(19) United States
(12) Patent Application Publication
(10) Pub. No.: US 2021/0394437 A1
(43) Pub. Date: Dec. 23, 2021

(54) METHODS AND SYSTEMS FOR THREE-DIMENSIONAL PRINTING

(71) Applicant: Prellis Biologics, Inc., Hayward, CA (US)

(72) Inventors: Melanie P. MATHEU, Hayward, CA (US); Erik BUSBY, Hayward, CA (US); Karl Johan Torbjorn BORGLIN, Hayward, CA (US); Christopher ROGERS, Hayward, CA (US); Hershel SHAH, Hayward, CA (US)

(21) Appl. No.: 17/163,089

(22) Filed: Jan. 29, 2021

Related U.S. Application Data
(63) Continuation of application No. PCT/US2019/044238, filed on Jul. 30, 2019.
(60) Provisional application No. 62/712,851, filed on Jul. 31, 2018.
(60) Provisional application No. 62/712,855, filed on Jul. 31, 2018.
(60) Provisional application No. 62/712,883, filed on Jul. 31, 2018.

(51) Int. Cl. B29C 64/153; B29C 64/393; B29C 64/268

(52) U.S. Cl. CPC B29C 64/153; B33Y 30/00; B29C 64/268; B29C 64/393

(57) ABSTRACT

The present disclosure provides methods and systems for the three-dimensional (3D) printing of 3D objects. Methods and systems provided herein may comprise 3D holographic lithography which may enable the 3D printing of various shapes. Methods and systems provided herein may enable high efficiency 3D holographic printing and may avoid, for example, problems zero-order defects. Methods and systems provided herein comprise methods for printing 3D objects with reduced or minimal inconsistency.

### CROSS-REFERENCE

This application is a continuation of International Application No. PCT/US2019/044238, filed on Jul. 30, 2019, which claims the benefit of U.S. Provisional Application No. 62/712,851, filed on Jul. 31, 2018, U.S. Provisional Application No. 62/712,855, filed on Jul. 31, 2018, and U.S. Provisional Application No. 62/712,883, filed on Jul. 31, 2018, Entitled: “Methods And Systems For Three-Dimensional Printing,” the contents of each are incorporated herein by reference in their entirety.

### BACKGROUND

Holographic lithography may be applied in the fabrication of three dimensional (3D) objects. This technique may combine holography with two-photon lithography to project a three-dimensional (3D) representation thereby exposing a photo-sensitive medium that undergoes polymerization to yield a three-dimensional (3D) object. This technology, also known as holographic three-dimensional (3D) printing, may be used for its combined fabrication resolution and speed. While potential applications are numerous, fabrication of biological materials may be a primary application. This is due to the resolution capabilities that allow for fabrication single cells and small capillaries, which may be inaccessible with other 3D printing technologies. Additionally, this direct-write fabrication technique allowing for the fabrication of 3D objects rather than laminar assembly of such 3D objects through a layer-by-layer process, as is used in more traditional lithography applications.

### SUMMARY

The present disclosure provides methods and systems for the three-dimensional (3D) printing of 3D objects. Methods and systems provided herein may comprise 3D holographic lithography. Methods and systems of the present disclosure may use, without limitation, holography and/or multi-photon absorption. The methods and systems of the present disclosure may enable the 3D printing of various shapes including pre-determined shapes and arbitrary shapes. Some aspects of the methods and systems may enable high efficiency 3D holographic printing and may avoid problems such as zero-order defects. Methods in the present disclosure may comprise methods for printing 3D objects with minimal inconsistency.

In an aspect, the present disclosure provides a method for processing a computer representation of a three-dimensional (3D) object, comprising: (a) computer processing the computer representation of the 3D object to generate a first plurality of parts of the 3D object, wherein the first plurality of parts have different volumes; (b) computer processing the first plurality of parts to yield a second plurality of parts that have substantially identical volumes; and (c) using the second plurality of parts to generate printing instructions for generating the 3D object.

In some embodiments, the method further comprises using the printing instructions to print the 3D object. In some embodiments, the 3D object is printed by curing a resin in accordance with the printing instructions. In some embodiments, the 3D object is printed by polymerizing a medium in accordance with the printing instructions.

In some embodiments, the second plurality of parts is part of a holographic representation of the 3D object. In some embodiments, the method further comprises generating a phase-space hologram by applying a phase-space transformation to the first plurality of parts. In some embodiments, the phase-space transformation is a translation operation.

In some embodiments, the 3D object is an amorphous 3D object. In some embodiments, a shape of a part of the first plurality of parts and a shape of a part of the second plurality of parts is selected in accordance with the compactness of each shape. In some embodiments, each shape is selected through a clustering algorithm. In some embodiments, the clustering algorithm is a k-means algorithm. In some embodiments, the clustering algorithm is a hierarchical clustering algorithm. In some embodiments, the method further comprises data mining.

In some embodiments, each of the second plurality of parts interlock. In some embodiments, each of the second plurality of parts is reassembled to create a jigsaw-puzzle-like lock.

Another aspect of the present disclosure provides a system for processing a computer representation of a three-dimensional (3D) object, comprising: a computer memory configured to store the computer representation of the 3D object; and one or more computer processors operatively coupled to the computer memory, wherein the one or more computer processors are individually or collectively programmed to: (i) obtain the computer representation of the 3D object from the computer memory; (ii) process the computer representation to generate a first plurality of parts of the 3D object, wherein the first plurality of parts have different volumes; (b) process the first plurality of parts to yield a second plurality of parts that have substantially identical volumes; and (c) use the second plurality of parts to generate printing instructions for generating the 3D object.

In some embodiments, the one or more computer processors are individually or collectively programmed to use the printing instructions to print the 3D object. In some embodiments, the 3D object is printed by curing a resin in accordance with the printing instructions. In some embodiments, the 3D object is printed by polymerizing a medium in accordance with the printing instructions.

In some embodiments, the second plurality of parts are part of a holographic representation of the 3D object. In some embodiments, the 3D object is an amorphous 3D object. In some embodiments, the each of the second plurality of parts interlock. In some embodiments, each of the second plurality of parts is reassembled to create a jigsaw-puzzle-like lock.

Another aspect of the present disclosure provides a method of generating a continuous hologram, the method comprising superimposing a first energy beam and a second energy beam such that the first energy beam generates a first zero-order defect and the second energy beam generates a second zero-order defect that does not overlap the first zero-order defect, to yield the continuous hologram.

In some embodiments, the continuous hologram is used to print a three-dimensional (3D) object. In some embodiments, the 3D object is printed by curing a resin. In some embodiments, the 3D object is printed by polymerizing a medium. In one embodiment the continuous hologram is a holographic representation of a three-dimensional (3D) object.

In some embodiments, the method further comprises providing a permutation of zero-order defect blocking and overlapping energy beam projection, such that the zero-order defect is non-overlapping and a large continuous 3D hologram is generated. In some embodiments, the first energy beam and the second energy beam are aligned. In some embodiments, the method further comprises physically blocking the zero-order defect in or near an image plane. In some embodiments, the method further comprises rejecting the zero-order defect using an angle-selective optic. In some embodiments, the angle-selective optic is a volumetric Bragg grating.

In some embodiments, the first energy beam and the second energy beam are handled separately. In some embodiments, the method further comprises setting an intensity of the first energy beam and the second energy beam such that each of the first energy and the second energy beam has sufficient energy to expose the first zero-order defect and the second zero-order defect to the first energy beam or the second energy beam. In some embodiments, the method further comprises each of the first energy beam and the second energy beam applies an increased intensity to either of the first zero-order defect or the second zero-order defect that exists within a print area of the first energy beam or the second energy beam.

Another aspect of the present disclosure provides a system for generating a continuous hologram, comprising: at least one energy source configured to direct a first energy beam or a second energy beam; one or more computer processors operatively coupled to the at least one energy source, wherein the one or more computer processors are individually or collectively programmed to superimpose the first energy beam and the second energy beam such that the first energy beam generates a first zero-order defect and the second energy beam generates a second zero-order defect that does not overlap the first zero-order defect, to yield the continuous hologram.

In some embodiments, the continuous hologram is used to print a three-dimensional (3D) object. In some embodiments, the 3D object is printed by curing a resin. In some embodiments, the 3D object is printed by polymerizing a medium. In some embodiments, the continuous hologram is a holographic representation of a three-dimensional (3D) object. In some embodiments, the one or more computer processors are individually or collectively programmed to provide a permutation of zero-order defect blocking and overlapping energy beam projection, such that the zero-order defect is non-overlapping and a large continuous 3D hologram is generated.

In some embodiments, the first energy beam and the second energy beam are aligned. In some embodiments, the first energy beam and the second energy beam are handled separately. In some embodiments, the one or more computer processors are individually or collectively programmed to further set an intensity of the first energy beam and the second energy beam such that each of the first energy and the second energy beam has sufficient energy to expose the first zero-order defect and the second zero-order defect to the first energy beam or the second energy beam. In some embodiments, the one or more computer processors are individually or collectively programmed to further comprise each of the first energy beam and the second energy beam applying an increased intensity to either of the first zero-order defect or the second zero-order defect existing within a print area of the first energy beam or the second energy beam.

Another aspect of the present disclosure provides a method for simultaneously printing a plurality of three-dimensional (3D) objects, comprising directing a plurality of holographic projections corresponding to the plurality of 3D objects into a medium comprising one or more precursors, to generate the plurality of 3D objects.

In some embodiments, the plurality of holographic projections is produced by directing at least one energy beam into a diffractive element. In some embodiments, the diffractive element is a diffractive beam splitter or a secondary spatial light modulator (SLM). In some embodiments, the plurality of holographic projections is produced by applying a beam steering device to at least one energy beam. In some embodiments, the individual 3D objects of the plurality of 3D objects are substantially identical to one another. In some embodiments, the plurality of 3D objects are different from one another. In some embodiments, the a 3D object of the plurality of 3D objects is selected from the group consisting of a scaffold, a mesh, a vasculature structure, a graft, a cell-encapsulating enclosure, a structural support, photonic structure, microfluidic structure, and micro electro-mechanical structure.

In some embodiments, the individual 3D objects of the plurality of 3D objects are part of a 3D structure. In some embodiments, the method further comprises combining the individual 3D objects to yield the 3D structure.

Another aspect of the present disclosure provides a system for simultaneously printing a plurality of three-dimensional (3D) objects, comprising: computer memory configured to store a computer representation of a plurality of holographic projections corresponding to the plurality of three-dimensional (3D) objects, a media chamber configured to contain a medium comprising one or more precursors, at least one energy source configured to direct at least one energy beam to the media chamber, and one or more computer processors operatively coupled to the at least one energy source, wherein the one or more computer processors are individually or collectively programmed to (i) obtain the computer representation of the plurality of holographic projections corresponding to the plurality of three-dimensional (3D) objects from the computer memory; and (ii) direct a plurality of holographic projections corresponding to the plurality of 3D objects into the medium comprising one or more precursors, to generate the plurality of 3D objects.

In some embodiments, the plurality of holographic projections is produced by directing at least one energy beam into a diffractive element. In some embodiments, the diffractive element is a diffractive beam splitter or a secondary spatial light modulator (SLM). In some embodiments, the plurality of holographic projections is produced by applying a beam steering device to at least one energy beam. In some embodiments, individual 3D objects of the plurality of 3D objects are substantially identical to one another. In some embodiments, individual 3D objects of the plurality of 3D objects are different from one another.

In some embodiments, a 3D object of the plurality of 3D objects is selected from the group consisting of a scaffold, a mesh, a vasculature structure, a graft, a cell-encapsulating enclosure, a structural support, photonic structure, microfluidic structure, and micro electro-mechanical structure. In some embodiments, individual 3D objects of the plurality of 3D objects are part of a 3D structure. In some embodiments, the one or more computer processors are individually or collectively programmed to further combine the individual 3D objects to yield the 3D structure.

Another aspect of the present disclosure provides a method for processing a computer representation of a three-dimensional (3D) object, comprising: (a) computer processing the computer representation of the 3D object to generate a holographic representation of the 3D object; (b) evaluating the holographic representation of the 3D object to generate a plurality of shape representations; (c) computer processing the plurality of shape representations to generate a partitioned holographic representation of the 3D object; and (d) using the partitioned holographic representation of the 3D object to generate printing instructions for generating the 3D object.

In some embodiments, each of the plurality of shape representations is a polygon. In some embodiments, the polygon is assigned a bounding volume. In some embodiments, each bounding volume comprises a plurality of sub-volumes. In some embodiments, each of the plurality of sub-volumes comprises a plurality of vectors. In some embodiments, the plurality of vectors are used to identify a plurality of intersected voxels. In some embodiments, the plurality of intersected voxels are stored in a hash table. In some embodiments, the evaluation of the holographic representation of the 3D object to generate a plurality of shape representations is the slicing of the holographic representation of the 3D object along planes of interest.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows an example of a method described herein.

FIG. 2 shows examples of models with and without a trailing image.

FIGS. 3A and 3B show a three-dimensional (3D) model of the “Stanford Bunny.” FIG. 3A shows an example of a portion of the 3D model comprising a plurality of 3D structures. FIG. 3B shows an example of the plurality of 3D structures of the portion of the 3D model being combined into a single hologram.

FIG. 4 shows examples of different methods of splitting an image.

FIG. 5 shows an example of applying a mask to an image in order to correct an unbalanced print.

FIG. 6 shows a computer control system that is programmed or otherwise configured to implement methods provided herein.

FIG. 7 shows an example of a method provided herein.

FIG. 8 shows an example of a method provided herein comprising the application of field correction to a hologram during holographic printing.

FIG. 9 shows examples of field correction masks.

FIG. 10 shows an example of a holographic lithography setup using a single input beam.

FIG. 11 shows an example of a holographic lithography setup using a single input beam and temporal focusing.

FIG. 12 shows an example of a holographic lithography setup using dual input beams.

FIG. 13 shows an example of a holographic lithography setup using dual input beams and temporal focusing.

FIG. 14 shows an example of a holographic lithography setup using dual input beams and dual primary modulators.

FIG. 15 shows an example of a holographic lithography setup using dual input beams and temporal focusing with an addressable focusing optic.

FIG. 16 illustrates an example of the utility of a superimposed beam system in holographic lithography.

FIG. 17 illustrates an example of a printed object with and without zero-order defect removal via beam superposition.

FIG. 18 shows an example of a parallel projection of a hologram that allows for simultaneous structure duplication.

FIG. 19 shows an example of a system provided herein comprising a diffractive optical element (DOE).

FIG. 20 shows an example of a system provided herein comprising beam steering.

FIG. 21 shows an example of a system provided herein comprising a diffractive optical element (DOE) and beam steering.

FIG. 22 illustrates a scheme of an example process for discretizing vector-based models by discretizing individual triangles

FIG. 23 shows an example of a holographic lithography setup using a single input beam and an angle-selective optic for zero order rejection.

FIG. 24 shows a system for using one light source to power multiple printers by splitting the incoming beam into multiple beams using polarization optics.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The terminology used herein is for the purpose of describing particular cases only and is not intended to be limiting. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

The term “about” or “approximately” refers to an amount that is near the stated amount by about 10%, 5%, or 1%, including increments therein. For example, “about” or “approximately” can mean a range including the particular value and ranging from 10% below that particular value and spanning to 10% above that particular value.

The term “biological material,” as used herein, generally refers to any material that may serve a chemical or biological function. The biological material may include a cell or multiple cells. The cells may be of the same type or different types. Biological material may be biologically functional tissue or functional tissue, which may be a biological structure that is capable of serving, or serving, a biomechanical or biological function. Biologically functional tissue may comprise cells that are within diffusion distance from each other, comprises at least one cell type wherein each cell is within diffusion distance of a capillary or vascular network component, facilitates and/or inhibits the fulfillment of protein function, or any combination thereof. Biologically functional tissue may be at least a portion of tissue or an organ, such as a vital organ. In some examples, the biological material may be used for drug development, such as, for example, screening multiple cells or tissue with different therapeutic agents.

Biological material may include a matrix, such as a polymeric matrix, including one or more other types of material such as proteins or cells. Biological material may be in various shapes, sizes or configurations. In some instances, biological material may be consumable by a subject (e.g., an animal), such as meat or meat-like material. The biological material may include macromolecules, such as polypeptides and/or protein.

The term “three-dimensional printing” (also “3D printing”), as used herein, generally refers to a process or method for generating a 3D part (or object). Such a process may be used to form a 3D part (or object), such as a 3D biological material.

The term “energy beam,” as used herein, generally refers to a beam of energy. The energy beam may be a beam of electromagnetic energy or electromagnetic radiation. The energy beam may be a particle beam. An energy beam may be a light beam (e.g., gamma waves, x-ray, ultraviolet, visible light, infrared light, microwaves, or radio waves). The light beam may be a coherent light beam, as may be provided by light amplification by stimulated emission of radiation (“laser”). In some examples, the light beam is generated by a fiber laser, a crystal-based laser, a laser diode, or a combination of multiple diode lasers.

Methods and systems of the present disclosure may use, without limitation, holography and/or multi-photon absorption. Multi-photon absorption is a process wherein multiple photons are absorbed effectively and substantially simultaneously as if they were a single photon of an energy equal to the sum of the energy of the individual photons. For example, two near-infrared photons (about 800 nm or about 1.2 electron volts (eV)) can be absorbed as if they were a single visible (about 400 nm or about 2.4 eV) photon. For this process to occur, it may require a high density of photons to occupy a volume substantially simultaneously. As a result, short pulse lasers with very high peak powers may be used to induce multi-photon absorption events. Additionally, this high density of photons may occur within an absorbing material with properties that may allow for the multi-photon absorption event to occur. If a material is not well suited for this, the incorporation of a molecular or nanoparticulate dye may sensitize a substantially unabsorbing material.

Multiphoton absorption may result in unique optical behavior, namely confinement of absorption to only the most intense portion of the focus of a beam. This is also known in microscopy applications as the focal point. For example, focusing light into a single photon absorbing material results in an absorption profile resembling an hour glass that extends throughout the entirety of the material thickness. In contrast, light focused in to a multi-photon absorbing material may result in an absorption profile resembling a small ellipsoid centered at the focal point of the beam. Because two photons may be absorbed at once, the likelihood of absorption of the two photons may decrease non-linearly as a function of the distance from the focal point squared. Because absorption, and thus printing, may decrease more rapidly at a distance from the focal point, this process may allow for higher resolution than single photon absorption and resolution tuning that is power based, unlike single photon absorption. Multi-photon absorbing materials may be selected to be transparent at the wavelength of the excitation laser. Absorbing materials may be selected such that they absorb at a wavelength roughly half of the excitation wavelength when using a two-photon absorption system. When using a 3-photon absorption system, absorbing materials may be selected such that they absorb one-third of the excitation wavelength. For example, a near-infrared two-photon dye is transparent in the near-infrared spectra region (about 1000 nm) and absorbing in the visible spectral region that is roughly half the wavelength of the laser (about 500 nm). Thus, when two long-wavelength, low energy photons comprising wavelength of about 1000 nm are absorbed simultaneously, they may impart the equivalent energy of a single, higher energy photon comprising a shorter wavelength of about 500 nm. Longer wavelengths have less scattering in dense media or tissues which may allow for the excitation light to penetrate deeper into a material than would be possible with single-photon techniques. In addition, because light may only be absorbed at the focal point, curing of a matrix (e.g. a polymeric matrix) may not occur above or below the focal plane unless directed to do so by the holographic printing method.

The combined advantages of excitation confinement and high optical transmissivity have made multi-photon optical techniques popular within bioscience imaging communities, where the technique has been applied to conduct high-resolution and deep tissue imaging of cells and tissues. Additionally, this technique has been applied to nano- and micro-fabrication using two-photon lithography (TPL). The aforementioned excitation confinement allows TPL to accomplish direct laser writing (DLW) fabrication of three-dimensional (3D) objects with resolution on the order of about one micron (μm) to about hundreds of nanometers (nm). While powerful, this technique may be limited to exposure of one voxel (i.e., the three-dimensional equivalent of a pixel) for the given amount of time required to cure a matrix (e.g., a polymeric matrix). This, if combined with beam steering hardware limitations and the exposure time requirements (dwell and also curing time) of the utilized photosensitive material, places an upper limit on the speed of a single-point exposure system. Compared to the scanning of a single focal point in traditional direct laser writing, holographic exposure may provide significant improvement in speed without significantly impacting the resolution of the technique.

Conceptually, holography is the optical projection of a three-dimensional image or “hologram.” Applied to multi-photon lithography, holography may allow for the exposure of many (i.e., about several thousand or more) voxels simultaneously in the x, y, or z dimension and thus, the facile fabrication of complex objects. A benefit to this approach relative to single-point exposure DLW may be print speed. Because many voxels may be exposed simultaneously, the print speed limit imposed by the dwell time of the print medium may no longer be a practical limit on the print speed of the system. Additionally, holography may allow for printing of two- and three-dimensional objects or object fragments in a single exposure. Hologram projection may be accomplished through modulating the phase and/or amplitude of a laser beam, possibly by an electronically addressable optical modulator. For example, a spatial light modulator (SLM) may be used. Fourier optics may be used to expose the print medium with the modulated beam.

A spatial light modulator (SLM) may be a device with electronically addressable pixels that imparts a variable phase delay to the impinging beam by electronically controlling the orientation of a liquid crystal. This variable phase delay may be controlled with an external computer to allow for the beam to be rapidly and precisely controlled. Depending on the imposed phase delay, the beam may be steered, focused, defocused, or arbitrarily shaped. The resultant phase profile can then be Fourier conjugated to transform the frequency-spatial domain profile imparted by the SLM into a spatial domain hologram projected into the intended print medium. This may be done by projecting the SLM phase profile (with the appropriate magnification/demagnification) onto the back aperture of a microscope objective.

A SLM may be an electrically programmable device that can modulate amplitude, phase, polarization, propagation direction, intensity or any combination thereof of light waves in space and time according to a fixed spatial (i.e., pixel) pattern. The SLM may be based on translucent, e.g. liquid crystal display (LCD) microdisplays. The SLM may be based on reflective, e.g. liquid crystal on silicon (LCOS) microdisplays. The SLM may be a microchannel spatial light modulator (MSLM), a parallel-aligned nematic liquid crystal spatial light modulator (PAL-SLM), a programmable phase modulator (PPM), a phase spatial light modulator (LCOS-SLM), or any combination thereof. An LCOS-SLM may comprise a chip that includes a liquid crystal layer arranged on top of a silicon substrate. A circuit may be built on the chip's silicon substrate by using semiconductor technology. A top layer of the LCOS-SLM chip may contain aluminum electrodes that are able to control their voltage potential independently. A glass substrate may be placed on the silicon substrate while keeping a constant gap, which is filled by the liquid crystal material. The liquid crystal molecules may be aligned in parallel by the alignment control technology provided in the silicon and glass substrates. The electric field across this liquid crystal layer can be controlled pixel by pixel. The phase of light can be modulated by controlling the electric field; a change in the electric field may cause the liquid crystal molecules to tilt accordingly. When the liquid crystal molecules tilt, the liquid crystal refractive indexes may change further changing the optical path length and thus, causing a phase difference.

Spatial light modulators (SLMs) may be used to print a three-dimensional (3D) biological material. The methods presented herein may comprise receiving a computer model of the 3D biological material in computer memory and further processing the computer model such that the computer model is “sliced” into layers, creating a two-dimensional (2D) image of each layer. The computer model may be a computer-aided design (CAD) model. The system disclosed herein may comprise at least one computer processor which may be individually or collectively programmed to calculate a laser scan path based on the “sliced” computer model, which determines the boundary contours and/or fill sequences of the 3D biological material to be printed.

Holographic three-dimensional (3D) printing may be performed with one or more polymer precursors. A SLM may be used with two or more polymer precursors. Various polymer precursors may be used.

A liquid crystal on silicon (LCOS)-SLM may be used to print the 3D biological material. A liquid crystal SLM may be used to print the 3D biological material. The SLM may be used to project a point-cloud representation or a lines-based representation of a computer model of the 3D biological material. The methods disclosed herein may comprise converting the point-cloud representation or lines-based representation into a holographic image. The SLM may be used to project the holographic image of the computer model of the 3D biological material. The SLM may be used to modulate the phase of light of a point-cloud representation or a lines-based representation of a computer model of the 3D biological material. The SLM may be used to modulate the phase of light of the holographic image of the computer model of the 3D biological material.

Projection of multi-photon excitation in three dimensions may also be achieved with the use of a dual digital micromirror device (DMD) system alone or in combination with a spatial light modulator (SLM). A pair of DMDs may be used with a pair of SLMs to print a 3D object using the methods described herein. At least one SLM and at least one DMD may be used to print a 3D object using the methods described herein. A pair of SLMs may be used to print a 3D object using the methods described herein. A pair of DMDs may be used to print a 3D object using the methods described herein. At least one SLM may be used to print a 3D object using the methods described herein. At least one DMD may be used to print a 3D object using the methods described herein. A DMD is an electrical input, optical output micro-electrical-mechanical system (MEMS) that allows for high speed, efficient, and reliable spatial light modulation. A DMD may comprise a plurality of microscopic mirrors (usually in the order of hundreds of thousands or millions) arranged in a rectangular array. Each microscopic mirror in a DMD may correspond to a pixel of the image to be displayed and can be rotated about e.g. 10-12° to an “on” or “off” state. In the “on” state, light from a projector bulb can be reflected into the microscopic mirror making its corresponding pixel appear bright on a screen. In the “off” state, the light can be directed elsewhere (for example, onto a heatsink), making the microscopic mirror's corresponding pixel appear dark. The microscopic mirrors in a DMD may be composed of highly reflective aluminum and their length across is approximately 16 micrometers (μm). Each microscopic mirror may be built on top of an associated semiconductor memory cell and mounted onto a yoke which may be connected to a pair of support posts via torsion hinges. The degree of motion of each microscopic mirror may be controlled by loading each underlying semiconductor memory cell with a “1” or a “0.” A voltage may be applied, which may cause each microscopic mirror to be electrostatically deflected about the torsion hinge to the associated +/− degree state via electrostatic attraction.

A multi-photon system may be used and such a system may be a two-photon system. In a two-photon system, illumination may be provided by a pulse laser. In some examples, an SLM may be used. In some examples, when using an SLM, illumination may be provided by a pulse laser.

The methods may further comprise addition of an optional beam expander which may be followed by a Bessel beam generating lens that is either a fixed axicon or a tunable acoustic gradient (TAG) lens which may be added to alter the properties of the laser which may achieve higher resolution and greater tissue printing depth, particularly in turbid solutions. The laser line, which may include the optional beam expander and/or Bessel beam generating lens, may be directed with fast switch mirrors to distinct projection systems that have material advantages in the formation of specific structures associated with tissue printing. In some cases, a high resolution DMD mirror in conjunction with an SLM system may achieve higher axial resolution than is capable with two SLM systems. Finally, a laser line may be used with a single DMD or SLM system in conjunction with a mirror to allow for scan-less projection of a two-dimensional image in any of the axial planes. A 3D projection pattern may also be raster-scanned across a larger field of view by scan mirrors where laser emission patterns, wavelength, and/or power may be controlled to match the raster scan speed such that a cohesive and complex structure may be deposited. Within the system containing more than one laser line, the configurations may be any combination of dual SLM, dual DMD, single SLM, single DMD or simple planar scanning.

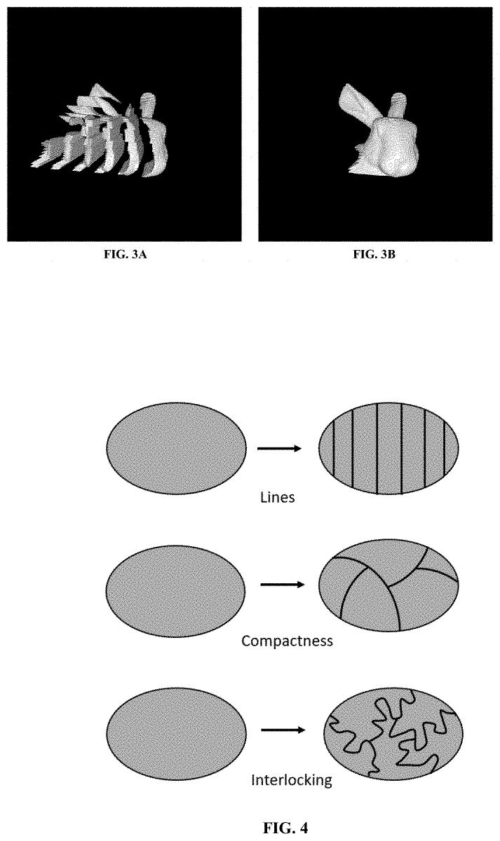

In some cases, one or more light paths may be used independently or in concert. The lenses, gratings, and mirrors that focus and distribute the light or energy beam within the optical path may be placed between the primary, wave-front shaping elements necessary to distribute the light through key elements or to modulate incoming light in the case of a grating, as described in FIG. 3A. At least one grating or mirror may be placed between wave-front shaping elements “F” (i.e., between an SLM, a DMD, and/or a TAG lens) for the purpose of focusing, distributing, or clipping the input laser light. The optical wave-front shaping device F may comprise an SLM, an LCOS-SLM, a DMD, a TAG lens, or any combination thereof.

In some cases, a digital micromirror device (DMD) may be used to print a 3D biological material. The DMD may be used to project a point-cloud representation or a lines-based representation of a computer model of the 3D biological material. The methods disclosed herein may comprise converting the point-cloud representation or lines-based representation into a holographic image. The DMD may be used to project the holographic image of the computer model of the 3D biological material. The DMD may be used to print the 3D biological material.

In some cases, a combination of at least one SLM and at least one DMD may be used in the methods disclosed herein to print the 3D biological material. The combination of at least one SLM and at least one DMD may be arranged in series. The combination of at least one SLM and at least one DMD may be arranged in parallel. The combination of any number of SLMs and any number of DMDs may be arranged in series when used to print the 3D biological material. The combination of any number of SLMs and any number of DMDs may be arranged in parallel when used to print the 3D biological material.

The combination of at least two SLMs and at least one DMD may be used to print the 3D biological material. The combination of at least three SLMs and at least one DMD may be used to print the 3D biological material. The combination of at least four SLMs and at least one DMD may be used to print the 3D biological material. The combination of at least five SLMs and at least one DMD may be used to print the 3D biological material. The combination of at least ten SLMs and at least one DMD may be used to print the 3D biological material. The combination of at least twenty SLMs and at least one DMD may be used to print the 3D biological material.

The combination of at least one SLM and at least two DMDs may be used to print the 3D biological material. The combination of at least one SLM and at least three DMDs may be used to print the 3D biological material. The combination of at least one SLM and at least four DMDs may be used to print the 3D biological material. The combination of at least one SLM and at least five DMDs may be used to print the 3D biological material. The combination of at least one SLM and at least ten DMDs may be used to print the 3D biological material. The combination of at least one SLM and at least twenty DMDs may be used to print the 3D biological material.

The combination of at least two SLMs and at least two DMDs may be used to print the 3D biological material. The combination of at least three SLMs and at least three DMDs may be used to print the 3D biological material. The combination of at least four SLMs and at least four DMDs may be used to print the 3D biological material. The combination of at least five SLMs and at least five DMDs may be used to print the 3D biological material. The combination of at least ten SLMs and at least ten DMDs may be used to print the 3D biological material. The combination of at least twenty SLMs and at least twenty DMDs may be used to print the 3D biological material.

In some examples, a DMD may not be used to perform the methods of the present disclosure. In some example, a DMD may be used to perform some parts of the process, but not all parts of the process.

A liquid crystal SLM may be used to print the 3D biological material. A plurality of SLMs may be used to print the 3D biological material. The plurality of SLMs can be arranged in series. The plurality of SLMs can be arranged in parallel. At least one or more SLMs may be used to print the 3D biological material. At least two or more SLMs may be used to print the 3D biological material. At least three or more SLMs may be used to print the 3D biological material. At least four or more SLMs may be used to print the 3D biological material. At least five or more SLMs may be used to print the 3D biological material. At least ten or more SLMs may be used to print the 3D biological material. At least twenty or more SLMs may be used to print the 3D biological material. At least one to about fifty or more SLMs may be used to print the 3D biological material. At least one to about twenty or more SLMs may be used to print the 3D biological material. At least one to about fifteen or more SLMs may be used to print the 3D biological material. At least one to about ten or more SLMs may be used to print the 3D biological material. At least one to about five or more SLMs may be used to print the 3D biological material.

A plurality of DMDs may be used to print the 3D biological material. The plurality of DMDs may be arranged in series. The plurality of DMDs may be arranged in parallel. At least one or more DMDs may be used to print the 3D biological material. At least two or more DMDs may be used to print the 3D biological material. At least three or more DMDs may be used to print the 3D biological material. At least four or more DMDs may be used to print the 3D biological material. At least five or more DMDs may be used to print the 3D biological material. At least ten or more DMDs may be used to print the 3D biological material. At least twenty or more DMDs may be used to print the 3D biological material. At least one to about fifty or more DMDs may be used to print the 3D biological material. At least one to about twenty or more DMDs may be used to print the 3D biological material. At least one to about fifteen or more DMDs may be used to print the 3D biological material. At least one to about ten or more DMDs may be used to print the 3D biological material. At least one to about five or more DMDs may be used to print the 3D biological material.

Within this lithographic framework, the pattern displayed on the SLM may determine the projected image and the object that may form in the print field of the system. The displayed SLM image may be the spatial-frequency domain image of the intended object print. Conceptually, this can be similar to the Fourier transform of the target projected image. Quantitatively, optimization beyond simple Fourier transform is necessary. Most commonly, the Gerchburg-Saxton algorithm can be used to calculate holograms, though there are a number of other algorithms capable of synthesizing holograms.

The present disclosure provides methods for generating a hologram, the method may comprise applying a first mask to a three-dimensional (3D) structure. The method may comprise providing a plurality of masks and algorithms. The method may comprise assigning a score to a voxel of the 3D structure. The plurality of masks and/or algorithms may be used to assign a score to the voxel. The plurality of masks, without limitation, may comprise 1 mask, 2 masks, 3 masks, 4 masks, 5 masks, or more. The plurality of algorithms, without limitation, may comprise 1 algorithm, 2 algorithms, 3 algorithms, 4 algorithms, 5 algorithms, or more. The 3D structure may be fractured into a plurality of parts. A second mask may be applied to the plurality of parts generated. This may generate a hologram. The generated hologram may be heterogeneous. Alternatively, the generated hologram may not be heterogeneous. Heterogeneous holograms may be undesired for practical purposes. The methods provided in this disclosure may further comprise methods for reducing and/or eliminating heterogeneities in the holograms. A second mask and/or a second algorithm may be used for reducing heterogeneity in the holograms. In some cases, a third mask/algorithm, or more masks/algorithms may be used to reduce heterogeneities in the holograms, may improve the consistency of the holograms, and may accomplish other goals.

The present disclosure provides methods for generating a hologram. The method may comprise superimposing a first energy beam and a second energy beam. The first energy beam may generate a first zero-order defect and the second energy beam may generate a second zero-order defect. The first zero-order defect and the second zero-order defect may not overlap in the hologram. In some cases, the first zero-order defect and the second zero-order defect may overlap in the hologram. The method may further comprise more energy beams. For example, 3, 4, 5, 6, 7, 8, 9, 10, or more energy beams may be used. More zero-order defects may be generated. For example, 3, 4, 5, 6, 7, 8, 9, 10, or more zero-order defects may be generated. The number of the beams used and the number of zero-order defects are not meant to be limiting. The multiple zero-order defects that may be generated may not overlap. In some cases, the zero-order defects may overlap. The generated hologram may be small, medium, or large. The method may further comprise any permutation of zero-order defect blocking and overlapping energy beam projection, such that the zero-order defect may be non-overlapping and a 3D hologram may be generated. The generated hologram may be continuous. The generated hologram may be consistent throughout its volume. The generated hologram may be small, medium, or large. For example, a large continuous 3D hologram may be generated.

Zero-order defects may originate from the unmodulated portion of a given spatial light modulator (SLM) surface. Each SLM surface within the system tasked with hologram projection, may produce a unique zero-order defect. Alternatively, the zero-order defects may not be unique. SLMs may be used in a tiled manner or in parallel. Parallel use of SLMs may be used to generate larger holograms compared to example cases where a single SLM is being used. Using SLMs in parallel may increase the throughput of the process. Multiple SLMs may be configured in various settings and optimized to accomplish various goals. For example, the tiled or parallel use of SLMs field may be projected such that a unique, non-overlapping zero-order defect, such as a continuous print-field may be generated.

The methods of the present disclosure may comprise simultaneously generating a plurality of three-dimensional (3D) structures. The methods may comprise directing at least one energy beam into a medium. The medium may comprise one or more precursors. The medium may further comprise other chemicals. This may generate a plurality of 3D structures. A diffractive element may be applied to at least one energy beam. The at least one energy beam may then be directed into the medium as a plurality of 3D projections which may correspond to the plurality of 3D structures.

In some examples, each one of the 3D structures in the plurality of 3D structures may be identical to each other. Alternatively, each one of the 3D structures in the plurality of 3D structures may be similar to one another. Alternatively, each one of the 3D structures in the plurality of 3D structures may be slightly different than one another. Alternatively, each one of the 3D structures in the plurality of 3D structures may be different than one another. Alternatively, each one of the 3D structures in the plurality of 3D structures may be substantially different than one another. Alternatively, each one of the 3D structures in the plurality of 3D structures may be completely different than one another.

In some cases, a diffractive element may be used. In some cases the diffractive element may be a diffractive beam splitter or a secondary spatial light modulator (SLM).

The methods of the present disclosure may comprise simultaneously generating a plurality of three-dimensional (3D) structures. The methods may comprise directing at least one energy beam into a medium comprising one or more precursors, to generate the plurality of 3D structures; and applying a beam steering device to the at least one energy beam. The at least one energy beam may then be directed into the medium as a plurality of 3D projections corresponding to the plurality of 3D structures.

Each one of the 3D structures in the plurality of 3D structures may be identical to each other. Each one of the 3D structures in the plurality of 3D structures may be repetitive. Each one of the 3D structures in the plurality of 3D structures may be similar to one another. Alternatively, each one of the 3D structures in the plurality of 3D structures may be slightly different than one another. Alternatively, each one of the 3D structures in the plurality of 3D structures may be different than one another. Alternatively, each one of the 3D structures in the plurality of 3D structures may be substantially different than one another. Alternatively, each one of the 3D structures in the plurality of 3D structures may be completely different than one another. Each one of the 3D structures in the plurality of 3D structures may have a unique structural configuration.

The methods may further comprise applying a spatial light modulator (SLM) to the at least one beam. The method may comprise using a beam steering element. The SLM may be timed to match the positioning of the beam steering element. The SLM may expand the addressable print field.

Methods and systems of the present disclosure may be used to print multiple layers of a 3D object, such as a 3D biological material. The methods may be performed at the same time. Alternatively, the methods may not be performed at the same time. For example, 3D object(s) may be formed of a polymeric material, a metal, metal alloy, composite material, or any combination thereof. The 3D object may be formed of a polymeric material. The 3D object may include biological material (e.g., one or more cells or cellular components). The 3D object may be formed by directing an energy beam (e.g., a laser) as a 3D projection (e.g., hologram) to one or more precursors of the polymeric material. This may induce polymerization (e.g., photopolymerization) and/or cross-linking to form at least a portion of the 3D object. This may be used to form multiple layers of the 3D object. Multiple layers may be formed at the same time or at substantially the same time. Alternatively different parts may be formed during different time intervals. The different parts may later be connected to each other. Alternatively, the parts may not be connected to each other.

The methods of the present disclosure may comprise printing a biological material. Methods may comprise providing a media chamber. The media chamber may comprise a first medium. The first medium may comprise a first plurality of cells and one or more precursor(s). The first precursors may be polymeric precursors. At least one energy beam may be directed to the first medium in the media chamber along at least one energy beam path in accordance with computer instructions for printing the 3D biological material, to subject at least a portion of the first medium in the media chamber to form a first portion of the 3D biological material. Next, a second medium may be provided in the media chamber. The second medium may comprise a second plurality of cells and a second polymeric precursor. The second plurality of cells may be of a different type than the first plurality of cells. Next, at least one energy beam may be directed to the second medium in the media chamber along at least one energy beam path in accordance with the computer instructions, to subject at least a portion of the second medium in the media chamber to form at least a second portion of the 3D biological material.

Biological material may comprise cells. In some cases, during or subsequent to formation of the 3D biological material, or some other time during the process, at least a portion of the subset of the plurality of cells may be subjected to differentiation to form cells of at least two different types. This may be employed, for example, by exposing the cells to an agent or subjecting the cells to a condition that induces differentiation. Alternatively or additionally, the cells may be subjected to de-differentiation.

The methods and systems may comprise providing a media chamber. Media chamber may comprise cells. The media chamber may be configured to contain a medium comprising a plurality of cells. Cells may comprise of one type of cells. Cells may comprise of at least 1, 2, 3, 4, 5, 6, 7, or more types of cells. Cells may be of any type of cells. Cells may be adherent or suspension cells. Cells may be healthy or diseased cells. Cells may be cancer cells or stem cells.

The medium may comprise one or more precursors. Precursors may be polymer precursors. The medium may comprise polymerizable material. The medium may comprise various chemicals. Chemicals may be present at varying ratios. Ratios may be adjusted and optimized for specific purposes and applications.

Cells may comprise endothelial cells, microvascular endothelial cells, pericytes, smooth muscle cells, fibroblasts, endothelial progenitor cells, lymph cells, T-cells such as helper T-cells and cytotoxic T-cells, B-cells, natural killer (NK) cells, reticular cells, hepatocytes, or any combination thereof. The first cell group and/or second cell group may comprise exocrine secretory epithelial cells, hormone-secreting cells, epithelial cells, nerve cells, adipocytes, kidney cells, pancreatic cells, pulmonary cells, extracellular matrix cells, muscle cells, blood cells, immune cells, germ cells, interstitial cells, or any combination thereof

Cells may comprise exocrine secretory epithelial cells including but not limited to salivary gland mucous cells, mammary gland cells, sweat gland cells such as eccrine sweat gland cell and apocrine sweat gland cell, sebaceous gland cells, type II pneumocytes, or any combination thereof.

Cells may comprise hormone-secreting cells including but not limited to anterior pituitary cells, intermediate pituitary cells, magnocellular neurosecretory cells, gut tract cells, respiratory tract cells, thyroid gland cells, parathyroid gland cells, adrenal gland cells, Leydig cells, theca interna cells, corpus luteum cells, juxtaglomerular cells, macula densa cells, peripolar cells, mesangial cells, pancreatic islet cells such as alpha cells, beta cells, delta cells, PP cells, and epsilon cells, or any combination thereof

Cells may comprise epithelial cells including but not limited to keratinizing epithelial cells such as keratinocytes, basal cells, and hair shaft cells, stratified barrier epithelial cells such as surface epithelial cells of stratified squamous epithelium, basal cells of epithelia, and urinary epithelium cells, or any combination thereof.

Cells may comprise nerve cells or neurons including but not limited to sensory transducer cells, autonomic neuron cells, peripheral neuron supporting cells, central nervous system neurons such as interneurons, spindle neurons, pyramidal cells, stellate cells, astrocytes, oligodendrocytes, ependymal cells, glial cells, or any combination thereof.

Cells may comprise kidney cells including but not limited to, parietal cells, podocytes, mesangial cells, distal tubule cells, proximal tubule cells, Loop of Henle thin segment cells, collecting duct cells, interstitial kidney cells, or any combination thereof.

Cells may comprise pulmonary cells including, but not limited to type I pneumocyte, alveolar cells, capillary endothelial cells, alveolar macrophages, bronchial epithelial cells, bronchial smooth muscle cells, tracheal epithelial cells, small airway epithelial cells, or any combination thereof.

Cells may comprise extracellular matrix cells including, but not limited to epithelial cells, fibroblasts, pericytes, chondrocytes, osteoblasts, osteocytes, osteoprogenitor cells, stellate cells, hepatic stellate cells, or any combination thereof.

Cells may comprise muscle cells including, but not limited to skeletal muscle cells, cardiomyocytes, Purkinje fiber cells, smooth muscle cells, myoepithelial cells, or any combination thereof.

Cells may comprise blood cells and/or immune cells including, but not limited to erythrocytes, megakaryocytes, monocytes, macrophages, osteoclasts, dendritic cells, microglial cells, neutrophils, eosinophils, basophils, mast cells, T-cells, helper T-cells, suppressor T-cells, cytotoxic T-cells, natural killer T-cells, B-cells, natural killer (NK) cells, reticulocytes, or any combination thereof.

The medium may comprise precursors. Precursors may be polymerizable material. Precursors may be polymer precursors. The polymerizable material may comprise polymerizable monomeric units that are biologically compatible, dissolvable, and, in some cases, may be biologically inert. The monomeric units (or subunits) may polymerize, cross-link, or react in response to the multi-photon laser beam to create cell-containing structures, such as cell matrices and basement membrane structures, specific to the 3D object (e.g., biological tissue) which may be generated. The monomeric units may polymerize and/or cross-link to form a matrix. In some cases, the polymerizable monomeric units may comprise mixtures of collagen with other extracellular matrix components including but not limited to elastin and hyaluronic acid to varying percentages depending on the desired tissue matrix.

Non-limiting examples of extracellular matrix components used to create cell containing structures may include proteoglycans such as heparan sulfate, chondroitin sulfate, and keratan sulfate, non-proteoglycan polysaccharide such as hyaluronic acid, collagen, and elastin, fibronectin, laminin, nidogen, or any combination thereof. These extracellular matrix components may be functionalized with acrylate, diacrylate, methacrylate, cinnamoyl, coumarin, thymine, or other side-group or chemically reactive moiety to facilitate cross-linking induced directly by multi-photon excitation or by multi-photon excitation of one or more chemical doping agents. In some cases, photopolymerizable macromers and/or photopolymerizable monomers may be used in conjunction with the extracellular matrix components to create cell-containing structures. Non-limiting examples of photopolymerizable macromers may include polyethylene glycol (PEG) acrylate derivatives, PEG methacrylate derivatives, and polyvinyl alcohol (PVA) derivatives. In some instances, collagen used to create cell containing structure may be fibrillar collagen such as type I, II, III, V, and XI collagen, facit collagen such as type IX, XII, and XIV collagen, short chain collagen such as type VIII and X collagen, basement membrane collagen such as type IV collagen, type VI collagen, type VII collagen, type XIII collagen, or any combination thereof.

Specific mixtures of monomeric units may be created to alter the final properties of the polymerized biogel. This base print mixture may contain other polymerizable monomers that are synthesized and not native to mammalian tissues, comprising a hybrid of biologic and synthetic materials. An example mixture may comprise about 0.4% w/v collagen methacrylate plus the addition of about 50% w/v polyethylene glycol diacrylate (PEGDA). Photoinitiators to induce polymerization may be reactive in the ultraviolet (UV), infrared (IR), or visible light range. Examples of such photo initiators are Eosin Y (EY) and triethanolamine (TEA), that, when combined may polymerize in response to exposure to visible light (e.g., wavelengths of about 390 to 700 nanometers). Non-limiting examples of photoinitiators may include azobisisobutyronitrile (AIBN), benzoin derivatives, benziketals, hydroxyalkylphenones, acetophenone derivatives, trimethylolpropane triacrylate (TPT), acryloyl chloride, benzoyl peroxide, camphorquinone, benzophenone, thioxanthones, and 2-hydroxy-1-[4-(hydroxyethoxy)phenyl]-2-methyl-1-propanone. Hydroxyalkylphenones may include 4-(2-hydroxyethylethoxy)-phenyl-(2-hydroxy-2-methyl propyl) ketone (Irgacure® 295), 1-hydroxycyclohexyl-1-phenyl ketone (Irgacure® 184) and 2,2-dimethoxy-2-phenylacetophenone (Irgacure® 651). Acetophenone derivatives may include 2,2-dimethoxy-2-phenylacetophenone (DMPA). Thioxanthones may include isopropyl thioxanthone.

Polymerizable material may be polymerizable biogel. Polymerized material may be polymerized biogel. Biogel may also be a resin, hydrogel, gel, polymer, polymerizable material for the purposes of the methods in the present disclosure. In some cases, the polymerized biogel may comprise at least about 0.01% of a photoinitiator. In some cases, the polymerized biogel may comprise about 10% of a photoinitiator or more. In some cases, the polymerized biogel comprises about 0.1% of a photoinitiator. In some cases, the polymerized biogel may comprise about 0.01% to about 0.05%, about 0.01% to about 0.1%, about 0.01% to about 0.2%, about 0.01% to about 0.3%, about 0.01% to about 0.4%, about 0.01% to about 0.5%, about 0.01% to about 0.6%, about 0.7% to about 0.8%, about 0.9% to about 1%, about 0.01% to about 2%, about 0.01% to about 3%, about 0.01%% to about 4%, about 0.01% to about 5%, about 0.01% to about 6%, about 0.01% to about 7%, about 0.01% to about 8%, about 0.01% to about 9%, or about 0.01% to about 10% of a photoinitiator.

In some cases, the polymerized biogel may comprise at most about 10% of a photoinitiator. In some cases, the polymerized biogel may comprise at most about 9%, at most about 8%, at most about 7%, at most about 6%, at most about 5%, at most about 4%, at most about 3%, at most about 2%, at most about 1%, at most about 0.09%, at most about 0.085%, at most about 0.08%, at most about 0.08%, at most about 0.075%, at most about 0.07%, at most about 0.065%, at most about 0.06%, at most about 0.055%, at most about 0.05%, at most about 0.045%, at most about 0.04%, at most about 0.035%, at most about 0.03%, at most about 0.025%, at most about 0.022%, at most about 0.02%, at most about 0.015, at most about 0.012%, at most about 0.01%, at most about 0.009%, at most about 0.008%, at most about 0.0075%, at most about 0.007%, at most about 0.0065%, at most about 0.006%, at most about 0.0055%, at most about 0.005%, at most about 0.0045%, at most about 0.004%, at most about 0.0035, at most about 0.003%, at most about 0.0025%, at most about 0.002%, at most about 0.0015%, at most about 0.001%, or less.

The polymerized biogel may comprise about 0.05% of a photoinitiator. The polymerized biogel may comprise 0.1% of a photoinitiator. The polymerized biogel may comprise about 0.2% of a photoinitiator. The polymerized biogel may comprise about 0.3% of a photoinitiator. The polymerized biogel may comprise about 0.4% of a photoinitiator. The polymerized biogel may comprise about 0.5% of a photoinitiator. The polymerized biogel may comprise about 0.6% of a photoinitiator. The polymerized biogel may comprise about 0.7% of a photoinitiator. The polymerized biogel may comprise about 0.8% of a photoinitiator. The polymerized biogel may comprise about 0.9% of a photoinitiator. The polymerized biogel may comprise about 1% of a photoinitiator. The polymerized biogel may comprise about 1.1% of a photoinitiator. The polymerized biogel may comprise about 1.2% of a photoinitiator. The polymerized biogel may comprise about 1.3% of a photoinitiator. The polymerized biogel may comprise about 1.4% of a photoinitiator. The polymerized biogel may comprise about 1.5% of a photoinitiator. The polymerized biogel may comprise about 1.6% of a photoinitiator. The polymerized biogel may comprise about 1.7% of a photoinitiator. The polymerized biogel may comprise about 1.8% of a photoinitiator. The polymerized biogel may comprise about 1.9% of a photoinitiator. The polymerized biogel may comprise about 2% of a photoinitiator. The polymerized biogel may comprise about 2.5% of a photoinitiator. The polymerized biogel may comprise about 3% of a photoinitiator. The polymerized biogel may comprise about 3.5% of a photoinitiator. The polymerized biogel may comprise about 4% of a photoinitiator. The polymerized biogel may comprise about 4.5% of a photoinitiator. The polymerized biogel may comprise about 5% of a photoinitiator. The polymerized biogel may comprise about 5.5% of a photoinitiator. The polymerized biogel may comprise about 6% of a photoinitiator. The polymerized biogel may comprise about 6.5% of a photoinitiator. The polymerized biogel may comprise about 7% of a photoinitiator. The polymerized biogel may comprise about 7.5% of a photoinitiator. The polymerized biogel may comprise about 8% of a photoinitiator. The polymerized biogel may comprise about 8.5% of a photoinitiator. The polymerized biogel may comprise about 9% of a photoinitiator. The polymerized biogel may comprise about 9.5% of a photoinitiator. The polymerized biogel may comprise about 10% of a photoinitiator.

In some cases, the polymerized biogel may comprise at least about 10% of a photopolymerizable macromer and/or photopolymerizable monomer. In some cases, the polymerized biogel may comprise about 99% or more of a photopolymerizable macromer and/or photopolymerizable monomer. In some cases, the polymerized biogel may comprise about 50% of a photopolymerizable macromer and/or photopolymerizable monomer. In some cases, the polymerized biogel may comprise about 10% to about 15%, about 10% to about 20%, about 10% to about 25%, about 10% to about 30%, about 10% to about 35%, about 10% to about 40%, about 10% to about 45%, about 10% to about 50%, about 10% to about 55%, about 10% to about 60%, about 10% to about 65%, about 10% to about 70%, about 10% to about 75%, about 10% to about 80%, about 10% to about 85%, about 10% to about 90%, about 10% to about 95%, or about 10% to about 99% of a photopolymerizable macromer and/or photopolymerizable monomer. The polymerized biogel may comprise about 40% photopolymerizable macromer and/or photopolymerizable monomer. The polymerized biogel may comprise about 45% of a photopolymerizable macromer and/or photopolymerizable monomer. The polymerized biogel may comprise about 50% of a photopolymerizable macromer and/or photopolymerizable monomer. The polymerized biogel may comprise about 55% of a photopolymerizable macromer and/or photopolymerizable monomer. The polymerized biogel may comprise about 60% of a photopolymerizable macromer and/or photopolymerizable monomer. The polymerized biogel may comprise about 65% of a photopolymerizable macromer and/or photopolymerizable monomer. The polymerized biogel may comprise about 70% of a photopolymerizable macromer and/or photopolymerizable monomer. The polymerized biogel may comprise about 75% of a photopolymerizable macromer and/or photopolymerizable monomer. The polymerized biogel may comprise about 80% of a photopolymerizable macromer and/or photopolymerizable monomer. The polymerized biogel may comprise about 85% of a photopolymerizable macromer and/or photopolymerizable monomer. The polymerized biogel may comprise about 90% of a photopolymerizable macromer and/or photopolymerizable monomer. The polymerized biogel may comprise about 95% of a photopolymerizable macromer and/or photopolymerizable monomer. The polymerized biogel may comprise about 96% of a photopolymerizable macromer and/or photopolymerizable monomer. The polymerized biogel may comprise about 97% of a photopolymerizable macromer and/or photopolymerizable monomer. The polymerized biogel may comprise about 98% of a photopolymerizable macromer and/or photopolymerizable monomer. The polymerized biogel may comprise about 99% of a photopolymerizable macromer and/or photopolymerizable monomer.

The polymerized biogel may comprise about 10% of a photopolymerizable macromer and/or photopolymerizable monomer. The polymerized biogel may comprise about 15% of a photopolymerizable macromer and/or photopolymerizable monomer. The polymerized biogel may comprise about 20% of a photopolymerizable macromer and/or photopolymerizable monomer. The polymerized biogel may comprise about 25% of a photopolymerizable macromer and/or photopolymerizable monomer. The polymerized biogel may comprise about 30% of a photopolymerizable macromer and/or photopolymerizable monomer. The polymerized biogel may comprise about 35% of a photopolymerizable macromer and/or photopolymerizable monomer. The polymerized biogel may comprise about 40% photopolymerizable macromer and/or photopolymerizable monomer. The polymerized biogel may comprise about 45% of a photopolymerizable macromer and/or photopolymerizable monomer. The polymerized biogel may comprise about 50% of a photopolymerizable macromer and/or photopolymerizable monomer. The polymerized biogel may comprise about 55% of a photopolymerizable macromer and/or photopolymerizable monomer. The polymerized biogel may comprise about 60% of a photopolymerizable macromer and/or photopolymerizable monomer. The polymerized biogel may comprise about 65% of a photopolymerizable macromer and/or photopolymerizable monomer. The polymerized biogel may comprise about 70% of a photopolymerizable macromer and/or photopolymerizable monomer. The polymerized biogel may comprise about 75% of a photopolymerizable macromer and/or photopolymerizable monomer. The polymerized biogel may comprise about 80% of a photopolymerizable macromer and/or photopolymerizable monomer. The polymerized biogel may comprise about 85% of a photopolymerizable macromer and/or photopolymerizable monomer. The polymerized biogel may comprise about 90% of a photopolymerizable macromer and/or photopolymerizable monomer. The polymerized biogel may comprise about 95% of a photopolymerizable macromer and/or photopolymerizable monomer. The polymerized biogel may comprise about 96% of a photopolymerizable macromer and/or photopolymerizable monomer. The polymerized biogel may comprise about 97% of a photopolymerizable macromer and/or photopolymerizable monomer. The polymerized biogel may comprise about 98% of a photopolymerizable macromer and/or photopolymerizable monomer. The polymerized biogel may comprise about 99% of a photopolymerizable macromer and/or photopolymerizable monomer.

In some examples, the 3D object may comprise a metal or metal alloy, such as, e.g., gold, silver, platinum, tungsten, titanium, or any combination thereof. In such a case, the 3D object may be formed by sintering or melting metal particles, as may be achieved, for example, by directing an energy beam (e.g., a laser beam) at a powder bed comprising particles of a metal or metal alloy. In some cases, the 3D object may be formed by directing such an energy beam as a 3D projection (e.g., hologram) into the powder bed to facilitate sintering or melting of particles. This may be used to form multiple layers of the 3D object at the same time. The 3D object may be formed of an organic material such as graphene. The 3D object may be formed of an inorganic material such as silicone. In such cases, the 3D object may be formed by sintering or melting organic and/or inorganic particles, as may be achieved, for example, by directing an energy beam (e.g., a laser beam) at a powder bed comprising particles of an organic and/or inorganic material. In some cases, the 3D object may be formed by directing such energy beam as a 3D projection (e.g., hologram) into the powder bed to facilitate sintering or melting of organic and/or inorganic particles.

Methods may comprise mixing or reacting polymerizable monomeric units with catalysts at some point before or during the holography process. For example, catalysts may be mixed with polymerizable monomeric units before the process, in which case it may be referred to as pre-mixing or pre-reacting. Alternatively, this may be done during the process.

Mixing may be integrated into the process. Reagents such as catalysts or other reagents may be delivered to certain reaction spots and mixed. Additional devices may be used to perform the reagent addition and/or mixing or its integration into the process. For example, different types of microfluidic devices and microchips may be incorporated in the setting using various configurations to perform reagent addition and mixing. Reagent addition and/or mixing may be automated using computer instructions. Process integration, parallelization, automation, and/or combinations thereof may increase the throughput and/or accuracy of the methods.

In some cases, photoinitiators may differ in their respective absorption wavelengths. This may allow for printing at different wavelengths to form different substrate-based structural elements simultaneously within the media chamber. Desired structural elements may be generated by tuning the excitation wavelength of the laser to a particular wavelength. Other structural elements may be generated around the existing elements by tuning another or the same laser to a different excitation wavelength that may interact with a distinct photoinitiator that initiates polymerization of one material base with greater efficiency. Likewise, different wavelengths may be used for different structural elements, wherein increased rigidity may be desired in some locations and soft or elastic structures may be desired in other locations. Because of the different physical properties of polymerizable materials, more rigid, soft, or elastic structures may be created in the same print step with the same cells by tuning the excitation wavelength of the laser electronically, by switching between different lasers, or by simultaneously projecting two different wavelengths.

Two-photon absorption may be non-linear and may not be capable of being accurately predicted or calculated based on single photon absorption properties of a chemical. A photo-reactive chemical may have a peak, two-photon absorption at or around double the single photon absorption or be slightly-redshifted in absorption spectra. Therefore, wavelengths at or about 900 nanometers through about 1400 nanometers may be used for polymerization of monomeric materials by exciting mixtures of catalysts of the polymerization reaction, for example EY or TEA. Single wavelength polymerization may be sufficient for creating all structural elements, however to further speed up the printing process, multiple wavelengths may be employed simultaneously through the same printing apparatus and into the same printing chamber. Computer instructions may be provided and/or used to perform such adjustments.

In some examples, the cells and/or tissues may be printed flush against the bottom of the media chamber. Such a design may allow for easy transport of printed tissues and/or their positioning under a laser print head (focusing objective). The system may be a closed system. A closed system may contribute to sterility. Using such a closed system may allow for media exchange and/or printing to occur without exposure to room air. This may be desired as exposure to room air may introduce infectious agents into the cell culture media which may disrupt or in some cases completely destroy the development of useful tissues.

The present disclosure provides a method for processing a computer representation of a three-dimensional (3D) object. The computer representation may be processed by a computer to generate a first plurality of parts of the 3D object. The parts of the 3D object may have different volumes. Alternatively, the parts may have similar volumes, or may be substantially similar in volume. The generated parts may be further processed by a computer to generate a second plurality of parts. The second plurality of parts may have substantially identical volumes. Alternatively, the second plurality of parts may have different volumes. The second plurality of parts may be used to generate printing instructions for generating the 3D object.

The methods may comprise providing computer instructions. Computer instructions may comprise printing instructions. The computer instructions may correspond to a computer model or representation of a 3D biological material. The computer instructions may be part of the computer model. The computer instructions may comprise an algorithm or a plurality of algorithms. The computer instructions may comprise a set of images corresponding to a 3D biological material.

The methods described herein may comprise providing printing instructions. Printing instructions may comprise computer instructions. Computer instructions may be computer programs, models, algorithm, software, and more. A computer representation described herein may comprise a point-cloud representation or a lines-based representation.

The system described herein may comprise one or more computer processors operatively coupled to at least one energy source and/or to at least one light patterning element. The point-cloud representation or the lines-based representation of the computer model may be a holographic point-cloud representation or a holographic lines-based representation. The one or more computer processors may be individually or collectively programmed to use the light patterning element to re-project the holographic image as illuminated by the at least one energy source.

In some cases, one or more computer processors may be individually or collectively programmed to convert the point-cloud representation or lines-based representation into an image. The one or more computer processors may be individually or collectively programmed to project the image in a holographic manner. The one or more computer processors may be individually or collectively programmed to project the image as a hologram. The one or more computer processors may be individually or collectively programmed to project the image as partial hologram. In some cases, one or more computer processors may be individually or collectively programmed to convert the point-cloud representation or lines-based representation of a complete image set into a series of holographic images via an algorithmic transformation. This transformed image set may then be projected in sequence by a light patterning element, such as a spatial light modulator (SLM) or digital mirror device (DMD), through the system, recreating the projected image within the printing chamber with the projected light that is distributed in 2D and or 3D simultaneously. An expanded or widened laser beam may be projected onto the SLMs and/or

DMDs, which serve as projection systems for the holographic image. In some cases, one or more computer processors may be individually or collectively programmed to project the image in a holographic manner. In some cases, one or more computer processors may be individually or collectively programmed to project the images all at once or played in series as a video to form a larger 3D structure in a holographic manner.

Printing may comprise laser printing. In laser printing of cellular structures, rapid three-dimensional structure generation using minimally toxic laser excitation may be important for maintaining cell viability. In the case of functional tissue printing, it may be necessary for large-format, high resolution, multicellular tissue generation. Other methods of two-photon printing may rely upon raster-scanning of two-photon excitation in a two-dimensional plane (x, y) (e.g., selective laser sintering), while moving the microscope or stage in the z direction to create a three-dimensional structure. This technique may be prohibitively slow for large format multicellular tissue printing such that cell viability may be unlikely to be maintained during printing of complex structures. Certain hydrogels with high rates of polymerization may also be utilized for two-dimensional projection of tissue sheets that are timed such that one slice of a structure is projected with each step in in an x, y, or z plane. Additionally, mixed plane angles representing a sheet or comprising an orthogonal slice may also be utilized. In the case of rapidly polymerizing hydrogels, these projections may work in time-scales that are compatible with tissue printing whereas laser sintering or raster scanning (e.g. layer-by-layer deposition) may be prohibitively slow for building a complex structure.

The methods of the present disclosure may comprise providing and using a laser printing system. The laser system may be equipped with an objective lens that may allow for focusing of the three-dimensional or two-dimensional holographic projection in the lateral and axial planes for rapid creation of cell-containing structures. The objective lens may be a water-immersion objective lens, an air objective lens, or an oil-immersion objective lens. In some cases, the laser printing system may include a laser system having multiple laser lines and may be capable of three-dimensional holographic projection of images for photolithography via holographic projection into cell-containing media.

The methods may comprise projecting a multi-dimensional (e.g. 2D and/or 3D) holographic image or a hologram. A laser that can photo-polymerize a medium may be projected as a hologram, The laser may photo-polymerize, solidify, cross-link, bond, harden, and/or change a physical property of the medium along the projected laser light path. The laser may allow for the printing of 3D structures. Holography may require a light source, such as a laser light or coherent light source, to create the holographic image. The holographic image may be constant over time or varied with time (e.g., a holographic video). Furthermore, additional elements may be used to perform the methods described herein. For example, a shutter may be used to open or block the laser light path, a beam splitter may be used to split the laser light into separate paths, mirrors may be used to direct the laser light paths, a diverging lens may be used to expand the beam, and additional patterning or light directing elements may be used as needed. Such elements may be configured and set up in various ways, in various orders, and various settings to perform the methods. None of the described elements are necessarily required. Alternatively, in some cases, one or more of the described elements may not be used to perform the methods of the present disclosure. For example, in some cases, the methods may be performed without using mirrors, or other elements.

A holographic image of an object may be created by expanding the laser beam with a diverging lens and directing the expanded laser beam onto the hologram and/or onto at least one pattern forming element, such as, for example a SLM. The pattern forming element may encode a pattern comprising the holographic image into a laser beam path. The pattern forming element may encode a pattern comprising a partial hologram into a laser beam path. Next, the pattern may be directed towards and focused in the medium chamber containing the printing materials (i.e., the medium comprising the plurality of cells and polymeric precursors), where it may excite a light-reactive photoinitiator found in the printing materials (i.e., in the medium). Next, the excitation of the light-reactive photoinitiator may lead to the photopolymerization of the polymeric-based printing materials and formation of a structure in the desired pattern (i.e., holographic image). In some cases, one or more computer processors may be individually or collectively programmed to project the holographic image by directing an energy source along distinct energy beam paths.

In some cases, at least one energy source may be a plurality of energy sources. The plurality of energy sources may direct a plurality of the at least one energy beam. The energy source may be a laser. In some examples, the laser may be a fiber laser. For example, a fiber laser may be a laser with an active gain medium that includes an optical fiber doped with rare-earth elements, such as, for example, erbium, ytterbium, neodymium, dysprosium, praseodymium, thulium and/or holmium. The energy source may be a short-pulsed laser. The energy source may be a femto-second pulsed laser. The femtosecond pulsed laser may have a pulse width less than or equal to about 500 femtoseconds (fs), about 250 fs, about 240 fs, about 230 fs, about 220 fs, about 210 fs, about 200 fs, about 150 fs, about 100 fs, about 50 fs, about 40 fs, about 30 fs, about 20 fs, about 10 fs, about 9 fs, about 8 fs, about 7 fs, about 6 fs, about 5 fs, about 4 fs, about 3 fs, about 2 fs, about 1 fs, or less. The femtosecond pulsed laser may be, for example, a titanium:sapphire (Ti:Sa) laser. The at least one energy source may be derived from a coherent light source.

The methods may comprise providing a light source. The light source may comprise a coherent light source. The coherent light source may provide light with a wavelength from about 300 nanometers (nm) to about 5 millimeters (mm). The coherent light source may comprise a wavelength from about 350 nm to about 1800 nm, or about 1800 nm to about 5 mm. The coherent light source may provide light with a wavelength of at least about 300 nm, about 400 nm, about 500 nm, about 600 nm, about 700 nm, about 800 nm, about 900 nm, about 1 mm, about 1.1 mm, about 1.2, mm, about 1.3 mm, about 1.4 mm, about 1.5 mm, about 1.6 mm, about 1.7 mm, about 1.8 mm, about 1.9 mm, about 2 mm, about 3 mm, about 4 mm, about 5 mm, or greater.

The system may further comprise at least one objective lens for directing the at least one energy beam to the medium in the media chamber. In some instances, at least one objective lens may comprise a water-immersion objective lens. In some instances, at least one objective lens may comprise a water-immersion objective lens. In some instances, at least one objective lens may comprise a water dipping objective lens. In some instances, at least one objective lens may comprise an oil immersion objective lens. In some instances, at least one objective lens may comprise an achromatic objective lens, a semi-apochromatic objective lens, a plans objective lens, an immersion objective lens, a Huygens objective lens, a Ramsden objective lens, a periplan objective lens, a compensation objective lens, a wide-field objective lens, a super-field objective lens, a condenser objective lens, or any combination thereof. Non-limiting examples of a condenser objective lens may include an Abbe condenser, an achromatic condenser, and a universal condenser.

The printing instructions may be used to print the 3D object. The 3D object may be printed by curing a resin in accordance with the printing instructions. The resin may be printed by polymerizing a medium in accordance with the printing instructions. The 3D object may be printed by polymerizing a medium in accordance with the printing instructions.

The resin may comprise a chemical or a plurality of chemicals. Chemicals may comprise polymers, precursors, polymer precursors, monomer unit, polymerizable materials, and more. Different chemicals may be combined and mixed to make resins. Resins may be altered and modified for different purposes. Resin chemistry may be adjusted, optimized, or changed. Some resins may need a light energy in order to be cured. In some cases, resins or polymerizable materials may not need a light source to be cured. Different types of resins may be used in solo or in combination for desired applications to perform the methods of the present disclosure.

The second plurality of parts may be part of a holographic representation of the 3D object. The holographic representation may be a patterned 3D holographic projection throughout a volume. The holographic representation may be a simultaneous generation of a plurality of points patterned as a 3D holographic projection throughout a volume. The holographic representation may be generated using at least one spatial light modulator. The holographic representation may be generated without use of a digital micromirror device. The 3D object may be an amorphous 3D object. Each of the second plurality of parts may interlock. Each of the second plurality of parts may be reassembled to create a jigsaw-puzzle-like lock. In some cases, the shape of the first plurality of parts and/or the shape of the second plurality of parts may be selected in accordance with the compactness of each of the shapes. The shapes of the parts may be selected using a clustering algorithm. The method may further comprise using data mining techniques. The clustering algorithm may be a k-means algorithm. The clustering algorithm may be a hierarchical clustering algorithm. The methods may comprise connectivity-based, centroid-based, distribution-based, and other types of clustering. The methods may comprise partitioning methods. The methods may comprise fuzzy clustering. The methods may comprise density-based clustering. The methods may comprise model-based clustering. The methods may comprise machine learning. The methods may comprise data mining. Various types of machine-learning, data mining, and cluster analysis techniques may be used.

The methods of the present disclosure may comprise providing a system for processing a computer representation of a three-dimensional (3D) object. The system may comprise a computer memory configured to store the computer representation of the 3D object; and one or more computer processors operatively coupled to the computer memory. The one or more computer processors may be individually or collectively programmed to obtain the computer representation of the 3D object from the computer memory, and process the computer representation to generate a first plurality of parts of the 3D object. The first plurality of parts may have different volumes. Alternatively, the first plurality of parts may have similar, identical, or close volumes. The first plurality of parts may then be processed to yield a second plurality of parts. The second plurality of parts may have substantially identical volumes. Alternatively, the second plurality of parts may have different volumes, or slightly different volumes. The volumes of the first and second plurality of parts are not meant to be limiting. The second plurality of parts may be used to generate printing instructions for generating the 3D object. The system may further comprise one or more computer processors individually or collectively programmed to use the printing instructions to print the 3D object. The 3D object may be printed by curing a resin in accordance with the printing instructions. The 3D object may be printed by polymerizing a medium in accordance with the printing instructions. The second plurality of parts may be part of a holographic representation of the 3D object. The holographic representation may be a patterned 3D holographic projection throughout a volume. The holographic representation may be a simultaneous generation of a plurality of points patterned as a 3D holographic projection throughout a volume. The holographic representation may be generated using at least one spatial light modulator. The holographic representation may be generated without use of a digital micromirror device.

In some cases, the methods of the present disclosure may further comprise generating a phase-space hologram. The phase-space hologram may be generated by applying a phase-space transformation to the first plurality of parts. The phase-space transformation may be a translation operation.

The phase-space may comprise the mathematical definition of a phase. The phase-space may comprise the wave definition of a phase. The phase may be the phase of a periodic function F. F(t) may be a function of a variable, such as t. The phase may be expressed as an angle, such as, ϕ(t), in such a scale that it varies by one full turn as the variable t goes through each period (and goes through each complete cycle). Thus, if the phase is expressed in degrees, it will increase by 360° as t increases by one period. If it is expressed in radians, the same increase in t will increase the phase by 2n. In plane wave optics, the phase may be an angle.

A translation operation may be performed using a translation operator. The translation operator may be a mathematical operator. The translation operator may be defined to shift locations and/or vectors and fields by a certain amount in a certain direction. For a function F(t), there may be a corresponding translation operator T (F(t)) that shifts locations, vectors, and/or fields by an example amount, such as δ. For example, T (F(t))=F (t+δ).

The 3D object may be an amorphous 3D object. Each of the second plurality of parts may interlock. Each of the second plurality of parts may be reassembled to create a jigsaw-puzzle-like lock.

The present disclosure provides a method of generating a continuous hologram. The method may comprise superimposing a first energy beam and a second energy beam such that the first energy beam generates a first zero-order defect and the second energy beam generates a second zero-order defect that does not overlap the first zero-order defect, to yield the continuous hologram.

The at least one energy beam may be directed as an image or image set. The image or image set may be fixed with time or changed over time. The at least one energy beam may be directed as a video. The at least one energy beam may be directed as a holographic image or video. This may enable different points in the medium to be exposed to the at least one energy beam at the same time, which may induce formation of a polymer matrix (e.g., by polymerization) at multiple layers at the same time. In some cases, a 3D image or video may be projected into the medium at different focal points using, e.g., a spatial light modulator (SLM).

In some examples, the at least one energy beam is at least 1, 2, 3, 4, 5, 6, 7, 8, 9, 10, 20, 30, 40, 50, 100, or more energy beams. The at least one energy beam may be coherent light or include coherent light. In some cases, the at least one energy beam is a laser beam.

The methods may comprise providing computer instructions. The computer instructions may comprise algorithms. The computer instructions may correspond to a computer model or representation of the 3D biological material. The computer instructions may be part of the computer model. The computer instructions may comprise a set of images corresponding to the 3D biological material. The computer instructions may include and/or direct adjustment of one or more parameters of the at least one energy beam as a function of time during formation of the 3D biological material, such as, for example, the application of power to a source of the at least one energy beam (e.g., laser on/off). Such an adjustment may be made in accordance with an image or video (e.g., holographic image or video) corresponding to the 3D biological material. Alternatively or in addition to, the computer instructions may include and/or direct adjustment of a location of a stage upon which the 3D biological material is formed.

The continuous hologram may be used to print a three-dimensional (3D) object. The 3D object may be printed by curing a resin. The 3D object may be printed by polymerizing a medium.

The continuous hologram may be a holographic representation of a three-dimensional (3D) object. The holographic representation may be a patterned 3D holographic projection throughout a volume. The holographic representation may be a simultaneous generation of a plurality of points patterned as a 3D holographic projection throughout a volume. The holographic representation may be generated using at least one spatial light modulator. The holographic representation may be generated without use of a digital micromirror device.

The method may further comprise any permutation of zero-order defect blocking and overlapping energy beam projection, such that the zero-order defect may be non-overlapping and a large continuous 3D hologram may be generated. The first energy beam and the second energy beam may be aligned. The first energy beam and the second energy beam may be handled separately.

The methods may further comprise blocking the zero-order defect. The zero-order defect may be blocked physically. The zero-order defect may be blocked in or near an image plane. For example, light from the zero-order defect may be physically blocked in or near an image plane. The methods may comprise rejecting the zero-order defect using an angle-selective optic. Angle-selective optic may be, for example, a volumetric Bragg grating.

The method may further comprise setting an intensity of the first energy beam and the second energy beam such that each of the first energy and the second energy beam may have sufficient energy to expose the first zero-order defect and the second zero-order defect to the first energy beam or the second energy beam. Each of the first energy beam and the second energy beam may apply an increased intensity to either of the first zero-order defect or the second zero-order defect that may exist within a print area of the first energy beam or the second energy beam.

The present disclosure provides a system for generating a continuous hologram. The system may comprise at least one energy source configured to direct a first energy beam or a second energy beam. The system may comprise one or more computer processors operatively coupled to the at least one energy source. The one or more computer processors may be individually or collectively programmed to superimpose the first energy beam and the second energy beam, such that the first energy beam generates a first zero-order defect and the second energy beam generates a second zero-order defect that may not overlap the first zero-order defect, to yield the continuous hologram. The one or more computer processors may be individually or collectively programmed to receive images of the edges of the 3D biological material. The one or more computer processors may be individually or collectively programmed to receive images of the exterior surfaces of the 3D biological material. The one or more computer processors may be individually or collectively programmed to receive images of the interior surfaces of the 3D biological material. The one or more computer processors may be individually or collectively programmed to receive images of the interior of the 3D biological material.

The one or more computer processors may be individually or collectively programmed to direct linking of the 3D biological material with other tissue, wherein such linking may be in accordance with the computer instructions. The one or more computer processors may be individually or collectively programmed to directly or indirectly link, merge, bond, or weld the 3D printed material with already printed structures, where linking is in accordance with the computer model. In some cases, linking of the 3D biological material with other tissue may involve chemical cross-linking, mechanical linking, and/or cohesively coupling.

The continuous hologram may be used to print a three-dimensional (3D) object. The 3D object may be printed by curing a resin. The 3D object may be printed by polymerizing a medium. The continuous hologram may be a holographic representation of a three-dimensional (3D) object. The holographic representation may be a patterned 3D holographic projection throughout a volume. The holographic representation may be a simultaneous generation of a plurality of points patterned as a 3D holographic projection throughout a volume. The holographic representation may be generated using at least one spatial light modulator. The holographic representation may be generated without use of a digital micromirror device.

Any permutation of the zero-order defect may block and overlap energy beam projection, such that the zero-order defect may be non-overlapping and a large continuous 3D hologram may be generated. The first energy beam and the second energy beam may be aligned. The first energy beam and the second energy beam may be handled separately.

The method further comprise setting an intensity of the first energy beam and the second energy beam, such that each of the first energy and the second energy beam may have sufficient energy to expose the first zero-order defect and the second zero-order defect to the first energy beam or the second energy beam. Each of the first energy beam and the second energy beam may apply an increased intensity to either of the first zero-order defect or the second zero-order defect that may exist within a print area of the first energy beam or the second energy beam.

The present disclosure provides a method for simultaneously printing a plurality of three-dimensional (3D) objects. The method may comprise directing a plurality of holographic projections corresponding to the plurality of 3D objects into a medium that may comprise one or more precursors, to generate the plurality of 3D objects.

The plurality of holographic projections may be produced by directing at least one energy beam into a diffractive element. The diffractive element may be a diffractive beam splitter or a secondary spatial light modulator (SLM). The plurality of holographic projections may be produced by applying a beam steering device to at least one energy beam.

Individual 3D objects of the plurality of 3D objects may be substantially identical to one another. Alternatively, Individual 3D objects of the plurality of 3D objects may be slightly different from one another. Alternatively, Individual 3D objects of the plurality of 3D objects may be substantially different from one another. Alternatively, Individual 3D objects of the plurality of 3D objects may be completely different from one another.

A 3D object of the plurality of 3D objects may be selected from the group consisting of a scaffold, a mesh, a vasculature structure, a graft, a cell-encapsulating enclosure, a structural support, photonic structure, a microfluidic structure, and a micro electro-mechanical structure. The individual 3D objects of the plurality of 3D objects may be part of a 3D structure.

The method may further comprise combining the individual 3D objects to yield the 3D structure. The plurality of holographic projections may be a plurality of patterned holographic projections throughout a volume. The plurality of holographic projections may be a plurality of simultaneously generated points patterned as the plurality of holographic projections throughout a volume. The plurality of holographic projections may be generated using at least one spatial light modulator. The plurality of holographic projections may be generated without use of a digital micromirror device.

The present disclosure provides a system for simultaneously printing a plurality of three-dimensional (3D) objects. The system may comprise one or more computer memories configured to store a computer representation of a plurality of holographic projections corresponding to the plurality of three-dimensional (3D) objects, a media chamber configured to contain a medium comprising one or more precursors, at least one energy source configured to direct at least one energy beam to the media chamber, and one or more computer processors operatively coupled to the at least one energy source. The one or more computer processors may be individually or collectively programmed to obtain the computer representation of the plurality of holographic projections corresponding to the plurality of three-dimensional (3D) objects from the computer memory, and direct a plurality of holographic projections corresponding to the plurality of 3D objects into the medium comprising one or more precursors, to generate the plurality of 3D objects.

The plurality of holographic projections may be produced by directing at least one energy beam into a diffractive element. The diffractive element may be a diffractive beam splitter or a secondary spatial light modulator (SLM). The plurality of holographic projections may be produced by applying a beam steering device to at least one energy beam.

Each individual 3D object of the plurality of 3D objects may be substantially identical to one another. Alternatively, the plurality of 3D objects may be slightly different from one another. Alternatively, the plurality of 3D objects may be substantially different from one another. Alternatively, the plurality of 3D objects may be completely different from one another.

A 3D object of the plurality of 3D objects may be selected from the group consisting of a scaffold, a mesh, a vasculature structure, a graft, a cell-encapsulating enclosure, a structural support, photonic structure, a microfluidic structure, and a micro electro-mechanical structure. Each individual 3D objects of the plurality of 3D objects may be part of a 3D structure. The method may further comprise combining the individual 3D objects to yield the 3D structure.

The plurality of holographic projections may be a plurality of patterned holographic projections throughout a volume. The plurality of holographic projections may be a plurality of simultaneously generated points patterned as said plurality of holographic projections throughout a volume. The plurality of holographic projections may be generated using at least one spatial light modulator. The plurality of holographic projections may be generated without use of a digital micromirror device.

The present disclosure provides methods and systems for dividing a three-dimensional (3D) shape into parts which can be printed using a holographic projection printer. The 3D shape may be an arbitrary 3D shape.

The throughput of a holographic projection printing system may depend on various factors. To be able to print a non-homogeneous structure, the hologram may be varied during the printing process. The update frequency of the hologram may depend both on the hardware used to create it, and the data stream that describes it. The efficiency of the system may vary as a function of the projection angle. As a result of this, a laser power which is usable for one angle may not be suitable for another. Thus, a balancing of laser power based on angles and depths of projection may be required to ensure a consistent printed structure.

The hologram may be generated using optical hardware. The generated hologram may have a high resolution. Alternatively, the hologram may have a medium resolution. Alternatively, the hologram may have intermediate or low resolution. The resolution of the hologram may be limited by the optical hardware used to produce it, which can also limit the volume of the hologram projection. Set hologram volumes may be achieved while maintaining a high contrast holographic projection and/or a high resolution holographic projection. Alternatively, a high contrast and/or high resolution may not be maintained while achieving set volumes of hologram projections.

A laser beam may be used for printing. The system throughput may depend on the properties of the laser beam. The laser wavelength can be chosen to match a single-photon or multi-photon absorption band of the print media. A multi-photon may be at least 2, 3, 4, 5, 6, 7, 8, 9, 10 or more photons. Alternatively, the multi-photon may be less than 10, 9, 8, 7, 6, 5, 4, 3, or less photons. The absorption band can be a multiple-photon absorption band.

The power of the laser may be modulated and adjusted. The power of the laser may be optimized for different purposes. The power of the laser may be high enough to cure the resin. The power of the laser may be adjusted to reach desired levels of curing. Curing may be partial or complete. Curing may occur at defined locations. Alternatively, curing may occur at random locations. For example, the power of the laser can be chosen to be located within the region where printing occurs. Printing may occur at various rates. The rate of curing may correlate with the rate of printing. This process may be referred to as photo-polymerization. The rate of printing may be adjusted through adjusting the power of the laser. The power of the laser may be high enough to cure the resin at a certain rate. Curing rate may be high, medium, or low. Curing rate is not meant to be limiting.

Laser beam exposure may potentially cause other events which may be desired. Alternatively, other events may be undesired. An example of an undesired event may be degradation of the resin. Degradation of the resin may be a chemical process. Degradation of the resin may be a physical process. Degradation of the resin may introduce a change into the chemical, physical, or physiochemical properties of the resin material. In some cases, the power of the laser beam may be higher than an example threshold which may potentially lead to the degradation of the resin. In some cases, the power of the laser beam may be higher than a certain threshold which may lead to the degradation of the resin. In some examples, the exposure time (the duration of time while the resin is being exposed to the laser beam) may be higher than a certain time period which may result in resin degradation. This event may be referred to as over-exposure. Over-exposure may be avoided by optimizing the laser power and/or exposure time.

The laser may be a pulsed laser. A pulsed laser may be programmed to generate specific pulses of laser exposure with a set power within defined time intervals. A pulsed laser may be used for multi-photon absorption. The laser power may be adjusted by altering the pulse energy and repetition rate of the laser.

The present disclosure provides a method of balancing the available laser power throughout a printing session for holographic projection by a holographic printing system. A constant laser power may be used. Alternatively, a variable laser power may be used. Having a laser power that is too low may lead to failure of the structure to be deposited (e.g., holographically printed). Having a laser power that is too high may damage and deform the structure to be deposited (e.g., holographically printed). Laser power and exposure time intervals may be optimized to achieve desired goals and/or avoid undesired events.

A holographic projection printer can project and focus laser light into a defined volume (“part”). The methods may comprise providing instructions for printing larger volumes (“shape”). A series of holograms may be used to print a large shape. A series of holograms may be used to print small, medium, or large shapes. The size of the shapes to be printed or the sizes of the printed objects are not meant to be limiting. The desired shape to be printed may be divided into multiple sections. Alternatively, the desired shape to be printed may not be divided into multiple sections. The desired shape to be printed may be divided into multiple sections while maintaining a constant laser exposure. Alternatively, a constant laser exposure may not be maintained while dividing the shape to be printed into multiple sections. The power of the laser may be modulated. Modulating the power of the laser may introduce some constraints on the printing speed. The refresh rate of the laser power may affect the printing speed. This may lead to a power loss.

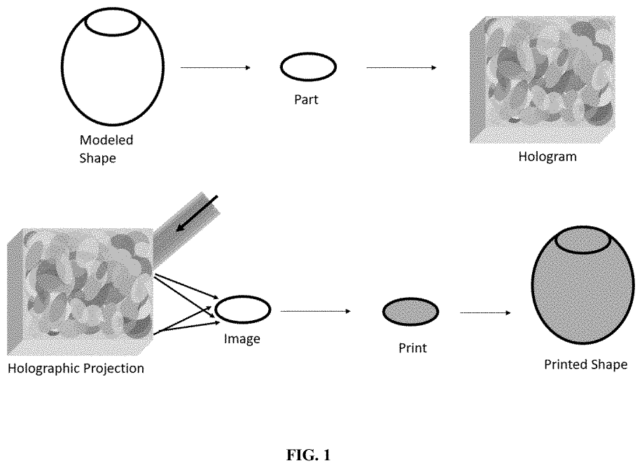

FIG. 1 schematically illustrates an example process for performing the methods of the present disclosure. Methods may comprise generating a modeled shape. The modeled shape may be used to generate a part. The part may be used to generate a hologram. The hologram may be converted into a holographic projection. The holographic projection may be used to generate an image. The image may be used to print a part. Parts may be used to generate the final printed shape.

The methods provided herein may comprise modifying and optimizing the holograms instead of the laser properties to ensure an even exposure. The methods may comprise modifying a hologram and/or splitting a hologram without the need to modulate the laser power. Alternatively, the laser power may also be modulated if needed. The method may comprise a voxelized 3D model which may represent the shape which is to be printed. The model can use many different data types to represent the shape to be printed. Each non-zero entry in the matrix which describes the model may correspond to a voxel to be printed, including discretized (matrix, CSV, etc.), image (TIF, PNG, etc.), and vector (STL, SVG, EPS, etc.) formats.

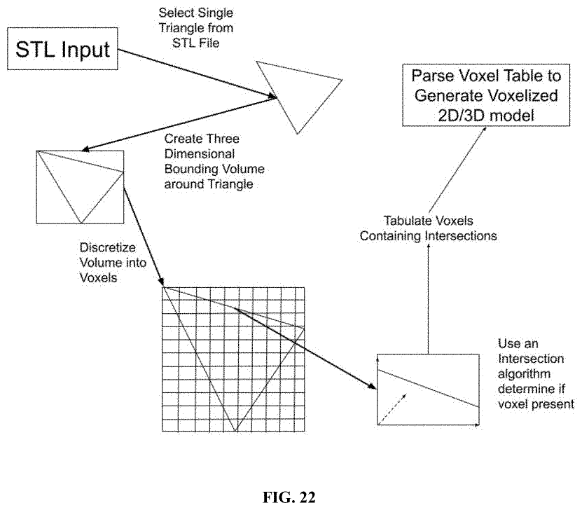

The processing modalities described may be most useful when computer assisted drawing (CAD) models are used as the input for model generation. This may pose a technical problem when CAD data formats, such as STL (also known as stereolithography or standard triangle language) filetype, describe models using a vectorized data format. Within this format, a shape may be represented as an assembly of polygons (most generally triangles) that may make up a mesh that may describe the surface of the model. Model processing may be done on a discretized model. The model may be described as a 3D arrangement (or matrix) of equally-sized cubic voxels. The interconversion of a vector-based model to a discretized model may be a non-trivial interconversion. An example method comprising using an STL model is schematically illustrated in FIG. 22. A single triangle may be selected from the STL file. A 3D bounding volume may be created around the triangle. The volume may be discretized into voxels. An intersection algorithm may be used to determine if example voxels contain intersections with the example triangle. Voxels containing intersections may be tabulated. The table of polygon containing or intersecting voxels may be parsed to generate a voxelized 2D/3D model.

The methods may comprise partitioning a 3D model. Partitioning may comprise discretizing and/or voxelizing. The methods may comprise voxelizing a 3D model. The methods may comprise partitioning a 3D model. Discretizing a 3D model may comprise computer-processing a 3D model to generate a plurality of shape representations of the 3D model to be discretized and/or partitioned and/or voxelized. The method may further comprise evaluating each of generated shape representations to generate/produce a model evaluation. The 3D model may be parsed based on the model evaluation. This may result in a discretized and/or voxelized and/or partitioned 3D model. The 3D model may be a vector-based 3D model.

The shape representations described herein may comprise polygonal shape representations (polygonal representations). Polygonal shape representations may comprise at least a polygon. Polygonal representations may comprise a plurality of polygons. Shape representations described herein may comprise triangular shape representations (triangular representations). Triangular representations may comprise at least a triangle. Triangular representations may comprise a plurality of triangles.

Shape representations described herein may comprise shape descriptors. In some cases, an index may be built for each shape representation. Shape representations may comprise probability distributions. In some examples, probability distributions may comprise Euclidean distances between pairs of randomly selected points on the surface of the 3D model. Shape representations may comprise reflective symmetry descriptors. Shape representations may comprise spherical harmonics and skeletal graphs.

The 3D model may comprise a vector-based 3D model. The vector-based 3D may comprise a plurality of vectors. A plurality of vectors may comprise at least a vector. Each of the plurality of shape representations may be assigned a bounding volume. Each bounding volume may comprise a plurality of sub-volumes. A plurality of sub-volumes may comprise at least one sub-volume. The bounding volume may comprise the shape representation, such as a polygon or a triangle. Each sub-volume may comprise a plurality of partitions. A plurality of partitions may comprise at least one partition. A partition may be a voxel.

The method may further comprise evaluating each sub-volume of the plurality of the sub-volumes. The method may further comprise re-calculating the bounding volume through an iterative mechanism/algorithm based on the evaluations performed on each sub-volume. Each sub-volume of the plurality of sub-volumes may correspond to a cuboid of the dimensions of the resolution of the model evaluation.

The method may further comprise performing an evaluation of each partition to determine if each partition is intersected by the shape representation so as to identify a plurality of intersected partitions. The evaluation may comprise evaluating intersections of the plurality of vectors contained within each of the plurality of sub-volumes. The method may comprise evaluating vectors residing on the faces and vertices of said plurality of sub-volumes. The method may also comprise vectors that are not residing on the faces and vertices of said plurality of sub-volumes. Evaluating the vectors may not be limited to the vectors residing on the faces and vertices of said plurality of sub-volumes. The method may further comprise storing the plurality of intersected partitions in a hash table. The hash table may be parsed along a plane of interest to generate a plurality of slices. The plurality of slices may generate a surface model. Parsing the hash table may be used to generate a multi-dimensional model. The multi-dimensional model may be, for example, a 2D model and/or a 3D model. The multi-dimensional model may be a solid model.

Slices may be parsed to find intersected surfaces producing a surface model. An algorithm may be used to fill the surface model to generate a solid model. The plurality of partitions may be a plurality of voxels.

For example, the methods of the present disclosure may comprise providing discretized vector-based models by discretizing individual triangles. An example of this is schematically illustrated in FIG. 22. This method may comprise parallel processing which may provide speedup when implemented. A computational representation, such as a triangle may be selected from the plurality of triangles that may be contained in the vector-based 3D model. The smallest cuboid that may contain the triangle may be selected as a bounding volume for the computation. In some cases, the smallest cuboid that can completely contain the triangle may be selected as a bounding volume for the computation. This may be done to limit the amount of computation that may be needed to evaluate each triangle (or other type of shape representation). The bounding volume may be subdivided into voxels. Each voxel is tested to determine if it intersects the triangular plane; this step may be done with a number of algorithms including, but not limited to, computing vector-plane intersections. If an intersection is found, the voxel is recorded in a hash table. This process is then completed for each triangle within the model. The end result of this calculation is a hash table containing all voxels that intersect with the model surface. This hash table may be parsed to provide a matrix-based representation of the discretized model data. The result will be a complete, discretized representation of all of the surfaces of the model. If a solid representation is desired, as is generally the case for 3D printing and similar applications, the surfaces may be filled to yield a solid representation of the modeled object. It should be noted that a triangular computer representation is discussed as an example, and computer representations are not limited to triangular representations. Instead, various types of shape representations may be used to discretize, partition and/or voxelize 3D models, such as vector-based 3D models.

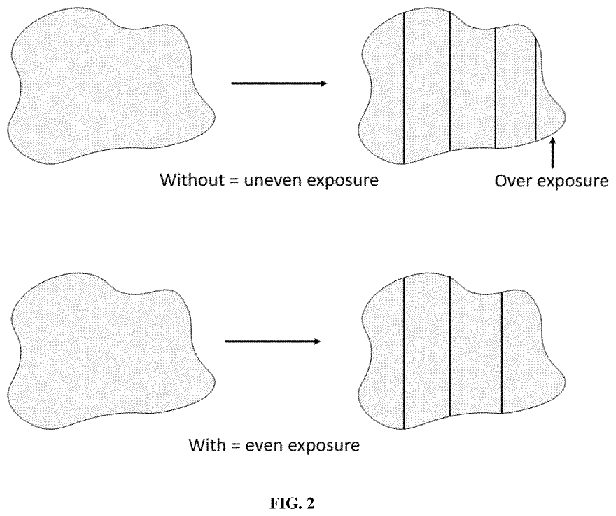

The present disclosure provides methods for generating a voxelized 3D model which may be divided into volumes represented by a 3D slice or plane comprising a significant x, y and z volume. The 3D slice or plane may be an amorphous 3D shape that spans the x, y, and z planes. The 3D slice or plane can be projected using the holographic projection printer. In some cases, the number of voxels per plane may remain constant throughout the model. However, for an arbitrary model, in some cases the number of voxels per plane may not remain constant throughout the model. In this case, the projection of a high-powered laser from a larger to a smaller volume may create structural inconsistencies. By pre-defining a number of voxels which may be known to be printable using a given set of system parameters, the laser power projected to parts of the model can be balanced. The approach to this may be to start in a corner and work down the rows and columns, assigning voxels to a part until the pre-defined number of voxels has been reached, and then move on to the next part. In some cases, this may lead to a trailing image with a lower number of voxels assigned to it, which may lead to overexposure by the laser (see FIG. 2).

FIG. 2 shows an example of a case where no balancing occurred between the parts. In such a case, a trailing part with a low number of voxels may result. Instead, a pre-defined number of voxels per plane may be used as an upper bound. By dividing the upper bound by the total number of voxels in the current plane and rounding up, the number of parts for the plane may be calculated. The total number of voxels may then be divided by the number of parts needed, which can give a new number of voxels to assign to each part.

A similar approach process may be applied to a 3D model. A hologram projection may not be limited to a single plane. A 3D model may contain a larger number of voxels than a plane. In this case, the result may be a collection of parts which may be better balanced in terms of pixels per part as compared to a 2D model (i.e., a plane). This may allow planes which themselves may contain fewer voxels than the desired number of voxels per holograms to be combined into a single hologram, as shown in FIGS. 3A and 3B.

FIG. 3A shows an example of a hologram of the “Stanford bunny,” split so that each slice has an equal number of voxels within each plane. The tip of the ears may contain a fewer number of voxels than the desired number of voxels per hologram, and several planes may be combined to a single hologram to balance this, as shown in FIG. 3B. Thus, the height or length of the ears may be printed nearly simultaneously as more voxels in the z dimension are projected at once. The planes shown in FIG. 3A may be 3D structures with heterogeneous edges that form interlocking parts.

The methods provided herein may comprise fracturing a hologram in 3D to create a balanced set of parts to be printed. To further enhance the throughput of the system, the 3D shape of each part may be optimized. To do this, the methods provided herein may further comprise scoring each part based on the compactness of the part. If the score for one of the parts of a set falls below a predefined threshold, that set of parts may be recombined and split again using a different method to produce more compact parts.

Methods are provided herein to re-split a set of parts, of a 3D shape, include seeding the plane with random points equal to the desired number of parts. The methods may further comprise growing these points into regions until all voxels have been assigned. The compactness of a part may be scored using a number of different methods. Non-limiting examples of these methods include Polsby-Popper, Schwartzberg, Minimum Convex, and Reock scores. These algorithms are available as part of many geographic information system projects, which aim to analyze, for example, the compactness of voter districts.

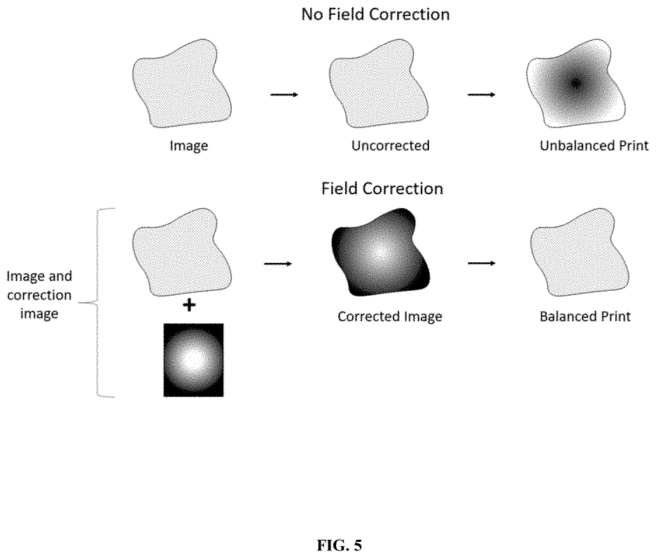

Additional variation in the shape of each part may be introduced to allow the parts to more efficiently interlock when recombining into the initial shape, by exchanging a small portion of two or more shapes over the shape borders, to create a jigsaw-puzzle-like lock. The process is illustrated in FIG. 4. While this increases the complexity of the part or hologram, it may not add to the print time, as the number of voxels remains constant. FIG. 4 Illustrates three different ways of splitting a 3D shape: a simple split by lines, splitting with the aim of achieving a more compact part, and splitting with the aim of creating interlocking parts.

In some cases, hardware limitations may cause the efficiency of a holographic projection printer to vary across the field which is being printed. To compensate for variations in a given set of hardware, a correction may be applied before the shape is fractured into parts. Unbalanced structures may be printed and the limitations within the hardware for consistent 3D projection can be manually defined. Each voxel of the shape may be assigned a score. A mask may be used to assign a score to each voxel of the shape. Each voxel of the shape may be assigned a score based on its position within the shape. For example, a voxel in a region where the printer is more efficient can be assigned a lower score. When the shape is split in accordance with the previous section, the voxels may be assigned to a part in such a way that the total score remains the same between the parts, instead of the number of voxels. This method may be applied on each plane of the shape individually or on the 3D model as a whole.

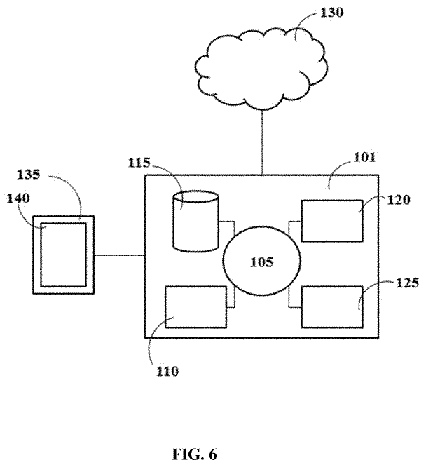

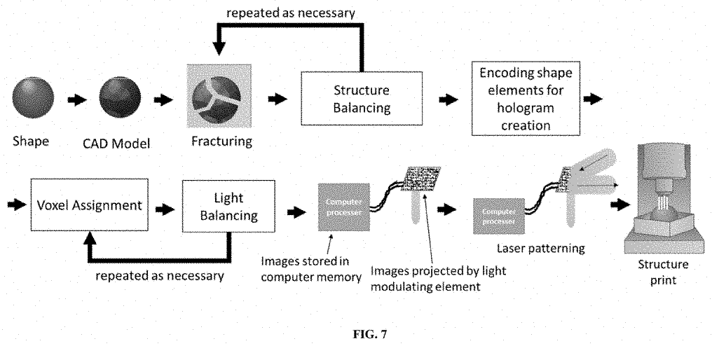

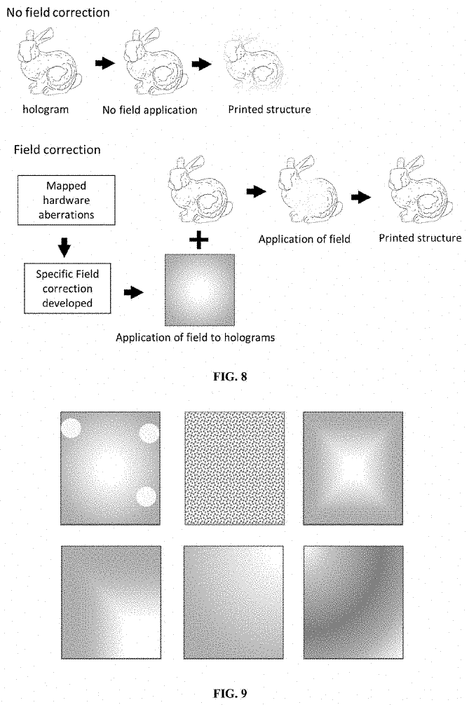

In some examples, a secondary mask can be applied to the part after it has been split from the shape. This mask may apply a higher number to example voxel(s) in regions of low efficiency, which may cause the algorithm that calculates the hologram to redirect more laser light to this region. This may cancel and/or compensate for small hardware aberrations that may have potentially induced heterogeneities in the projection. This approach may compensate for the differences in print efficiency among different parts in the print field. This method may also be applied on each plane, to a volume section, on the shape individually, or on the 3D model as a whole. An example of this method is illustrated in FIG. 5. As shown in FIG. 5, without post fracture field correction, the variations or aberrations can lead to efficiency of the hardware which may cause uneven printing. By applying a mask to the image before the corresponding hologram is calculated, the uneven print may be corrected. FIG. 6 shows a computer system that may be used to perform the methods provided herein. FIG. 7 shows an example procedure for performing an example method provided herein. FIG. 8 shows an example of a method provided herein comprising the application of field correction to a hologram during holographic printing. FIG. 9 shows examples of field correction masks.

The methods and systems of the present disclosure may comprise methods for circumventing the zero-order problem using beam superposition. In some cases, a pair of beams may illuminate the energy beam system. This may be done by placing a reflective beam splitter in the energy beam line to separate the input beam into two beams. In some cases, each beam may be independently configured. The pair of beams may then follow analogous paths to the spatial light modulator (SLM) (or SLMs). In some cases, the pair of beams may follow through separate sets of coupling optics, until they are combined at a point before the microscope objective. The beams may be recombined using a beam splitter. Recombination of the pair of beams may be done in a nearly lossless manner using a waveplate and a polarizing beam splitter.

Alternatively, in some examples, recombination of the pair of beams may be done using a partially reflective beam splitter to recombine the beams with some incurred efficiency loss. Efficiency loss may be at least about 10%, 20%, 30%, 40%, 50%, 60%, 70%, 80%, or more. Efficiency loss may be less than about 80%, 70%, 60%, 50%, 40%, 30%, 20%, 10%. For example, efficiency loss may be 50%. The use of a waveplate and a polarizing beam splitter may be preferred. The use of a waveplate and a polarizing beam splitter may provide improved efficiency. The method provided herein may comprise a number of individual SLMs that may be coupled to project one large field hologram, as a zero order defect can arise for each individual SLM used. The method provided herein may be applicable to numerous permutations and SLM arrangements.

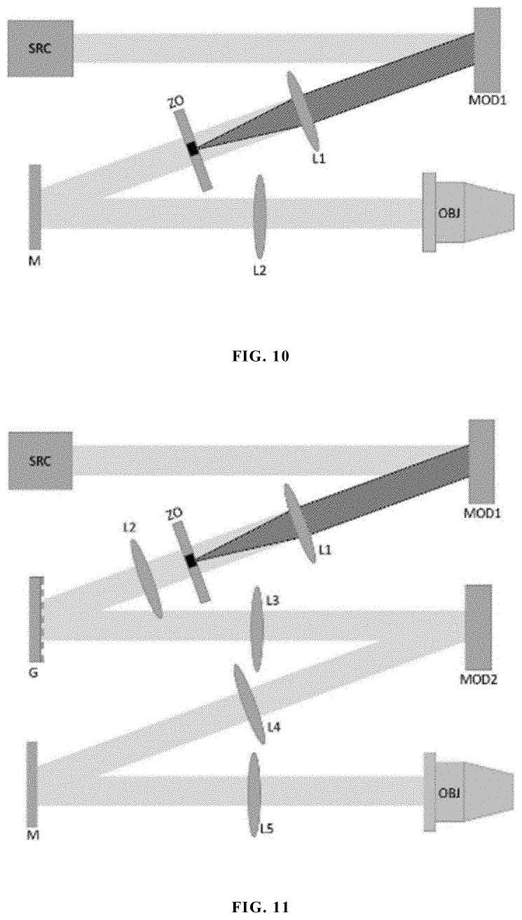

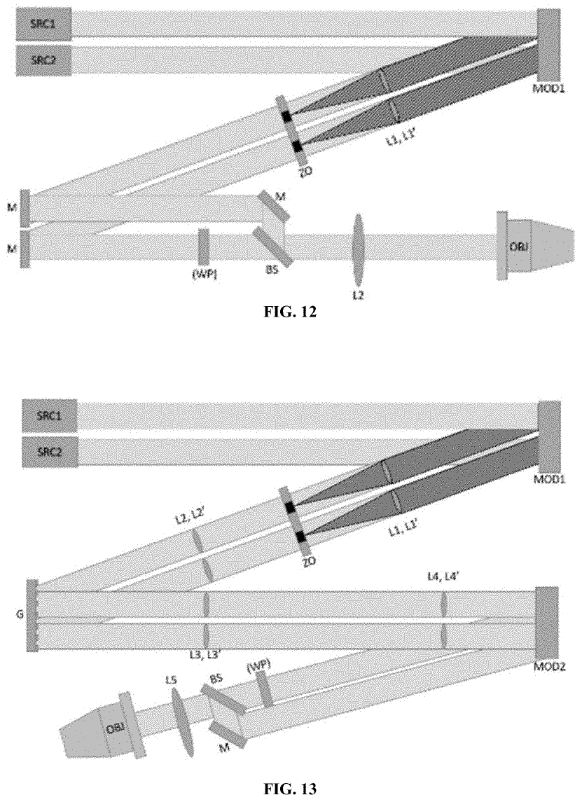

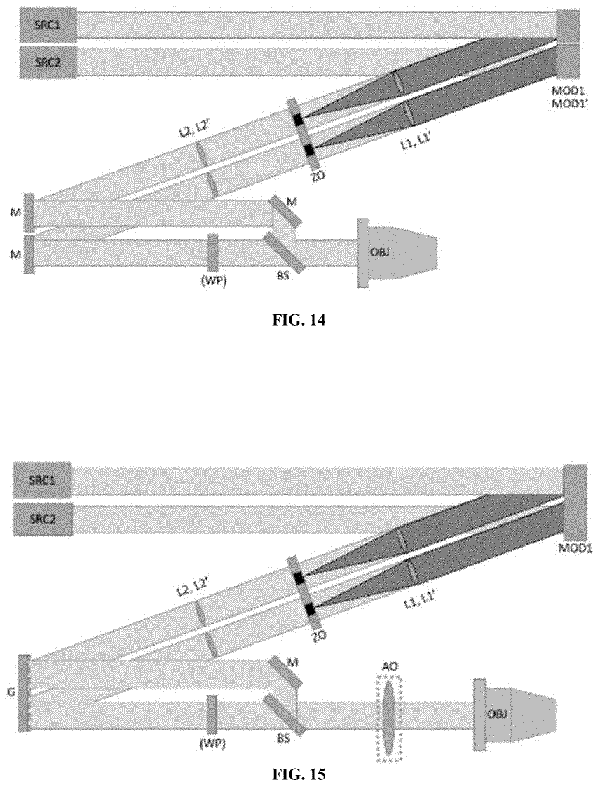

FIGS. 12-14 show an example of holographic lithography setups using dual input beams. FIG. 13 shows a dual input beam system with temporal focusing. FIG. 14 shows a dual input beam system with dual primary modulators. In contrast, FIGS. 10 and 11 show example holographic lithography setups with a single input beam. FIG. 11 shows an example holographic lithography setup comprising temporal focusing in addition to the single input beam. In FIGS. 10-15, the zero-order position of the beam is depicted with stripes. In addition, in FIGS. 10-15, the abbreviation “AO” corresponds to addressable optic (e.g., a variable lens), the abbreviation “G” corresponds to grating, the abbreviation “L” corresponds to lens, the abbreviation “M” corresponds to mirror, the abbreviation “OBJ” corresponds to microscope objective, the abbreviation “MOD” corresponds to optical modulator (e.g., a spatial light modulator), the abbreviation “SRC” corresponds to an illumination source, the abbreviation “WP” corresponds to a waveplate (e.g., a 212 waveplate), and the abbreviation “ZO” corresponds to zero order blocking device. STL corresponds to “standard triangle language”. The abbreviation “ASO” refers to an angle-selective optic

The beams may be aligned so they enter the objective co-linearly, such that it may yield a single print field. In some cases the optical components for each beam may be nearly identical. Alternatively, the optical components for each beam may be slightly different, substantially different, or in some cases, completely different. The resulting images from each beam may be similar. Alternatively, the resulting images from each beam may be different. In some cases, there may be important differences among the resulting images from each beam. For example, during hologram generation, the two beams may be handled separately. In this case, the same target image/object may be used for each beam, but the image may be offset from the center by a fixed distance but from different directions for each beam. In other examples, other scenarios may apply and other variations and differences may exist or be generated in any time and place during the process. In some cases, such variations may result in each beam rendering the image plane off-center, relative to the zero-order spot. As a result, the zero-order defect from each beam may be offset, and the two zero order defects may not overlap. In an example 3D printing of a biological material, two half-exposed zero-order spots in the print field may result instead of a single, dead-spot in the center of the print field. This event may be undesired and/or problematic. Undesired events caused by such event may be prevented by several approaches. For example, the power may be set such that each beam has sufficient energy to expose the target/print. This may make the half-exposure spots to be completely printed. In another example, the half exposure(s) in the holograms may be compensated for, such that each beam may apply an additional energy (e.g., laser, fluorescence, or any other desired type of light with any desired wavelength) dose to the spot that overlaps with the paired beams' dead spot. Such techniques may provide systems that may be capable of printing a full field with minimal zero-order defect from unmodulated light or the blocking thereof. Such systems may be capable of printing a full field without a zero-order defect from unmodulated light or the blocking thereof. In some cases, residual zero-order defect from unmodulated light or the blocking thereof may exist. In some cases, zero-order defect from unmodulated light or the blocking thereof may exist.

Methods and systems provided herein may enable optical 3D printing without zero-order defects. This may allow for holographic lithography of arbitrary shapes without this limitation.

In some examples, the methods and systems provided herein may be used to stitch together multiple SLMs into a single print system. Stitching together multiple SLMs may allow for simultaneous concerted or independent projection, which may be important in some cases, for example, when the system requirements exceed the capabilities of existing hardware. In this example, output from multiple SLMs may be directly overlaid to expose multiple patterns simultaneously within a single print field. Alternatively, in other examples, multiple SLMs may be combined non-co-linearly (with appropriate adjustment to the imaging magnification) to act as a single larger and/or higher resolution SLM. In the non-colinear case, each SLM may be imaged to a different area of the objective back aperture. The non-colinear combination of SLMs may provide the additional benefit of expanded field of view by decreasing the effective pixel size.

The methods and systems provided herein may be used to stitch together an arbitrary number of beams. While combination of two beams is depicted in the figures, this may be done for clarity. In principle, there is no limit to the number of beams that may be combined using the methods and systems provided herein. In some cases, recombining two beams using a polarizing beam splitter may be the optimal case. In some examples, recombining more than two beams using a partially reflective beam splitter, may incur in additional efficiency losses.

The methods and systems provided herein may be used with multiple energy sources (e.g., laser sources). In some cases, the energy source may be a wavelength degenerate energy source. In some cases, the energy source may be a non-degenerate energy source capable of one or two photon excitation. Furthermore, in some examples, the non-degenerate energy source may specifically allow for two-color-two-photon absorption. Two-photon absorption may be induced by absorption of two photons of differing wavelengths. In some examples, the two-color-two-photon absorption may have the potential to further improve resolution, because polymerization may occur only within a focal volume that is simultaneously exposed with both wavelengths of light. Controlling the focal volumes of each wavelength of light independently may allow for the overlap (and, therefore, the resolution) to be tuned.

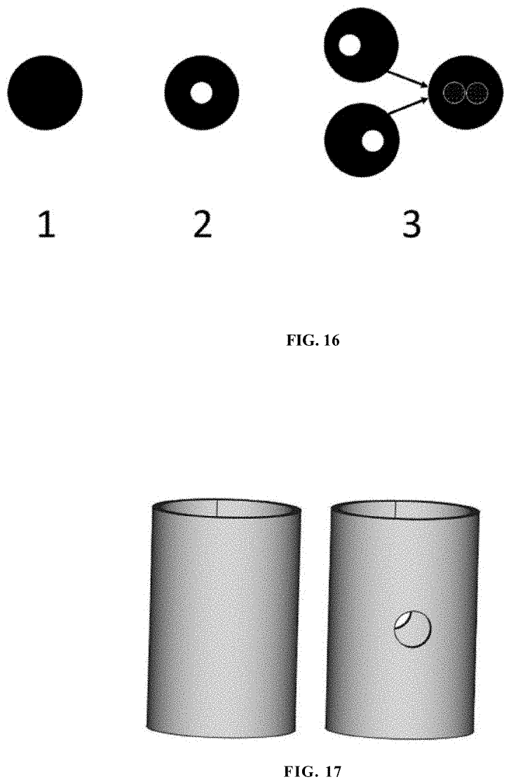

In some examples, holographic lithography systems may benefit from incorporation of components that are better optimized for this application. In some cases, the secondary SLM that is used to display a lens phase may be replaced with an electronically-addressable variable focus optical element. For example, FIG. 15 shows a holographic setup using dual input beams and temporal focusing, wherein an addressable focusing optic is used in place of the secondary SLM. In FIG. 15, the zero-order portion of the beam is displayed with stripe. The methods and systems provided herein may comprise a variable focus optical element. In some cases, the variable focus optical element may be electronically-addressable. In some examples, the variable focus optical element may be a variable focus lens. In some examples, the variable focus optical element may be a variable focus mirror. In some examples, the variable focus optical element may be a digital micromirror device. The use of a variable focus optical element may provide higher throughput. The use of a variable focus optical element may provide minimized zero-order ghost images. In some cases, zero-order ghost images may result from unmodulated light from a second SLM imaging onto the z=0 plane in the print field. In some examples, a zero-order ghost image may arise from the relative inefficiency of SLM-based modulation. In some cases, the inefficiency of SLM-based modulation may have peak efficiencies of about 90% at most. In some cases, the inefficiency of SLM-based modulation can have peak efficiencies of about 80% at most. In some cases, the inefficiency of SLM-based modulation may have peak efficiencies of about 70% at most. In some cases, the inefficiency of SLM-based modulation may have peak efficiencies of about 60% at most. In some cases, the inefficiency of SLM-based modulation may have peak efficiencies of about 50% at most. In some cases, the inefficiency of SLM-based modulation may depend on the SLM configuration. In some cases, the inefficiency of SLM-based modulation may depend on the displayed hologram.

The methods and systems provided herein may comprise an anti-reflection coated adjustable lens. In some cases, an anti-reflection coated adjustable lens system may be at least about 50%, 60%, 70%, 80%, 90, 95%, or more efficient. In some cases it may be less than about 100%, 95%, 90%, 80%, 70%, 60%, 50%, 40%, or less efficient. In some cases there may be with little-to-no dependence on the applied focal power of the lens. This may minimize loss.

Additionally, in a holographic projection system using temporal focusing, replacing the reflective diffraction grating with a transmissive diffraction grating may provide additional benefits. The methods and systems provided herein may comprise a transmissive diffraction grating. While reflective gratings may be efficient in their optimal geometry (for example, in Littrow configuration), reflective gratings may cause significant losses in the geometry required for holographic lithography. Transmissive gratings may provide additional flexibility in alignment geometry. Additionally, transmissive gratings may have higher damage thresholds than reflective gratings, which may be important for applications using high power lasers for illumination.

The methods and systems for beam superposition may also be applied to holographic projection using temporal focusing. In an example, a method or system provided herein comprises a diffraction grating. The diffraction grating may be placed into an intermediate image plane within the beam line. In some cases, the diffraction grating may improve the axial resolution. In this system, the first SLM may display an XY-plane hologram, which can then be imaged onto the diffraction grating. The beam may be directed onto a secondary SLM after being transmitted through the diffraction grating. The secondary SLM may display a lensing phase to provide Z-axis displacement of the preformed XY-hologram in the final projection. In this case, the beams can be recombined after the secondary SLM. If using an adjustable focusing optic, rather than an SLM, the system may be designed to recombine the beams before or after the focusing optics. This additional flexibility is possible because these focusing optics may be generally polarization insensitive, unlike most SLMs.

The application of this to 3D printing of a biological material may be significant in that defects such as holes or blank spaces in the print field when the zero-order spot may be manually blocked or minimal, partial, and in some cases significant burning in the material (i.e., zero-order defects) can otherwise disrupt the vascular flow or structural integrity of the 3D biological material, such as a scaffold. In a generalized manufacturing process, defects such as holes or blank spaces in a printed field (i.e., zero-order defects) can cause problems with structural integrity. The zero-order defects may be system-wide. In some examples, zero-order defects may be local. For example, a large defect may be the result of joining several print fields, each of which can contain a similar defect. In other examples, each of the print fields, or some of print fields may contain different defects.

In a printed 3D biological material, for example vasculature that require water-tight channels in which fluid can flow through, having such defects that may be repaired or that leak may be prohibitive for building a functional vasculature. In an example, FIG. 16 shows the utility of a superimposed beam system in holographic lithography. FIG. 16 shows the intended print shape labeled as “1,” the resultant print with a zero-order defect, using a typical single beam system, labeled as “2,” and the print shape from the individual beams and the superposition of the dual beams, labeled as “3.” As shown in FIG. 16, the resultant print with the dual beam system “3” can be equivalent to the target image “1.” The individual zero-order spots in the superimposed image “3” in FIG. 16 are shown for reference only.

While the 3D printing methods and systems may allow for “repair” or revisiting of sites where defects in the print field are introduced by the zero order defect, this may slow the printing process and introduces potential heterogeneous structural integrity. The zero-order defect may be a blocked beam. The zero-order defect may create an empty, unprinted column throughout the 3D structure. Furthermore, the zero-order defect may effectively create a break-point or a point of weakness in a pressurized, 3D biological material system (e.g., a printed vasculature). Therefore, the methods and systems provided herein comprise eliminating zero-order defects which may improve the efficiency and printing accuracy of the printing and development of 3D biological material (e.g., microvasculature). In yet another example, FIG. 17 shows an illustration of a printed object with and without zero-order defect removal via beam superposition. FIG. 17 demonstrates the utility of the methods and systems provided herein, particularly for the 3D holographic printing of a watertight 3D biological structure (e.g., vasculature).

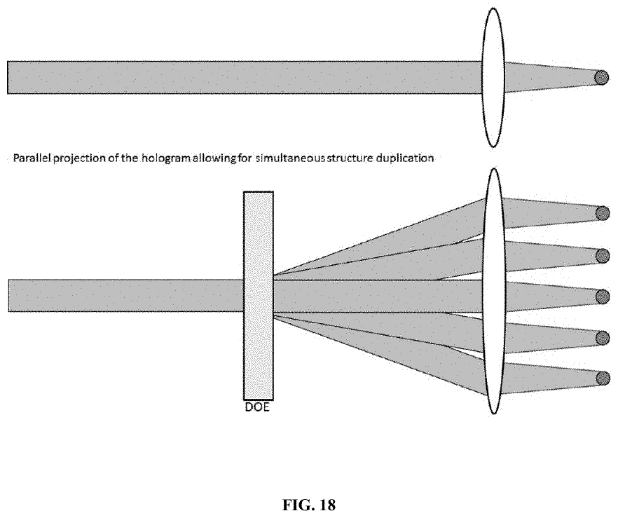

The present disclosure provides methods and systems for generating parallel duplicate holograms, projecting duplicating holographic images in an expanded print field, expanded holographic print fields with non-duplicating structures, and production of replicate 3D holographic elements. Projection may be done at various rates. Projection may be done rapidly. Alternatively, projection may be done slowly. FIG. 18 shows an example of a parallel projection of a hologram that allows for simultaneous structure duplication.

Holographic lithography can provide a powerful tool for lithography, but with some additional modifications, the utility may be further expanded. Fabrication of an object by holographic lithography may be done by forming a phase-shaped energy beam and Fourier coupling such that the beam may be projected via a microscope objective into a print medium to form a three-dimensional (3D) image which may then result in a three-dimensional (3D) object. The complexity of the optics may be in the wavefront shaping that can be accomplished by the spatial light modulator (SLM). In the case where multiple objects (or unit cells in a repeating structure) are fabricated, the printing process may benefit from incorporation of beam replication optics. In some examples, the beam replication optics may include diffractive beam splitters. In this case, a diffractive element is placed between the primary SLM and the microscope objective. In other examples, the beam replication optics are secondary SLMs. In some cases, the diffractive element may be a diffractive beam splitter. In some cases, the diffractive element is a secondary SLM.

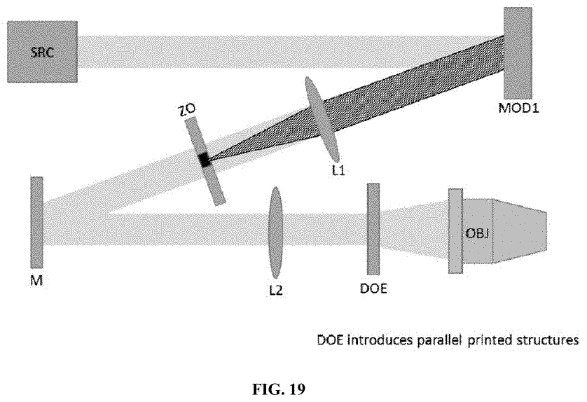

Using a diffractive element placed immediately before the microscope objective, the phase-shaped beam may be split into a plurality of identical beams that differ only in their entrance angle to the objective. The phase profile of the input beam may be conserved in all output beams. In other words, the plurality of identical beams may have the same modulated phase. Furthermore, the plurality of identical beams may not comprise destructive and/or constructive interference. The result may be the simultaneous projection of a plurality of images and fabrication of the resulting objects. FIG. 19 shows an example of a system provided herein comprising a diffractive optical element (DOE).

In some cases, the size and shape of the fabricated objects may be defined by the primary SLM. The number and position of the objects may be defined by the diffractive beam splitter. The use of a diffractive holographic element (e.g., a diffractive beam splitter) may allow for facile parallelization of a single object into a plurality of objects, as long as sufficient laser power and field of view is available. This technique may hold particular utility in the printing of a 3D biological material. One example is for organelles where many of the same structures may be fabricated en masse. Additionally, this technique may be utilized to simultaneously print many unit cells of a repeating structure. Non-limiting examples of a repeating structure include a scaffold, a mesh, a vasculature structure, and a graft. In this arrangement, the print field of the unit cell may be chosen to match the resultant image pitch from the combined holographic beam splitter and microscope objective. The image pitch is also known as the pixel pitch or pixel spacing, which refers to the distance from the center of one pixel to the center of the next. The result may be the ability to print large areas of potentially complex repeating structures simultaneously. One of the advantages of the methods and systems described herein may be the relatively high efficiency of holographic beam splitters, in terms of printing speed and number of objects that may be simultaneously, holographically printed. Another one of the advantages of the methods and systems described herein is the facile incorporation of the diffractive holographic element into an existing holographic lithography system.

In some cases, the methods and systems described herein comprise the use of a secondary spatial light modulator (SLM) as the diffractive element. In this case, a secondary SLM may be placed in the Fourier plane (i.e., the spatial-frequency plane) of the beam. In some cases, the secondary SLM may be addressed with a pattern that results in the replication of the incoming phase-shaped beam into multiple diffracted beams. This pattern may be a one or two dimensional grating to give a uniform arrangement of printed objects, similar to that of the holographic beam splitter. Alternatively, in other cases, the secondary SLM may display a hologram corresponding to an arbitrary set of focal points. The end result may comprise a phase profile created by the primary SLM that can be effectively replicated and directed to an arbitrary number of points in arbitrary locations. The methods and systems provided herein comprise the use of a secondary SLM for parallelized printing, similar to the above configuration with a holographic beam splitter. However, the use of a secondary SLM may provide the additional flexibility of individually placing each object. In some cases, the use of a secondary SLM may increase in system complexity. The use of a secondary SLM may decrease efficiency owing to SLM diffraction generally being less efficient than that of holographic beam splitting elements.

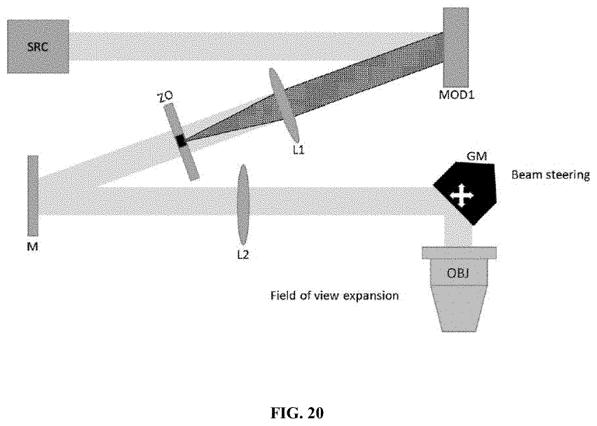

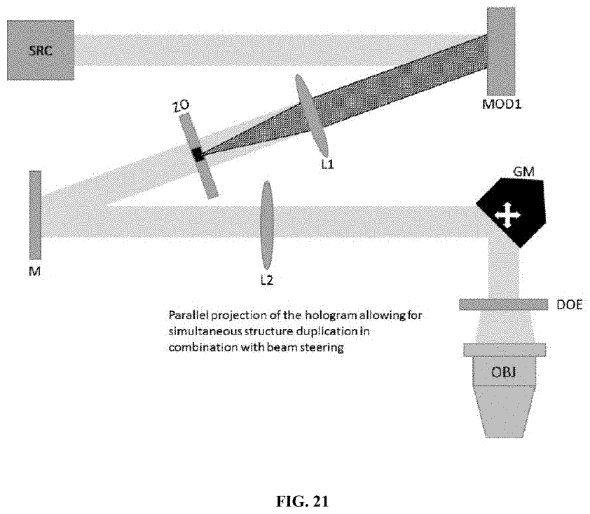

In some cases, the methods and systems described herein comprise the use of a beam steering device. The beam steering device may provide additional flexibility and utility in holographic lithography, both with and without beam replication optics. Beam steering optics may take many forms, including motorized kinematic mirrors, galvo-mirrors, acousto-optical modulators, or an additional spatial light modulator. Without beam replication optics, beam steering may allow for rastering of a holographically formed pattern. For example, rastering of a holographically formed pattern can comprise projecting a ring and rastering the ring orthogonally to the plane of the ring to form a tube. Rastering of a holographically formed pattern may provide particular utility in fabricating highly repetitive or symmetric structures. Additionally, rastering of a holographically formed pattern may be used with beam replication optics to allow for similar fabrication en masse. An example of fabrication en masse may comprise projecting a ring, using the displacement optics to raster the ring, and using the diffractive optical element(s) to replicate this rastering ring, wherein the resultant structure may be an array of simultaneously fabricated tubes. Finally, beam steering may be employed to expand a given field of view or printing frame beyond what is addressable with a given SLM field of projection. By timing SLM-based projection with positional beam steering, an entire field of view may be filled with a printed structure. This printed structure may otherwise not be addressable except by movement of the large stage or microscope objective (i.e., the print head), which may be both slower and less accurate than what may be achieved with beam steering. Timing SLM-based projection with positional beam steering may expand the addressable print field without having to increase the number and/or size of the SLM. FIG. 20 shows an example of a system provided herein comprising beam steering. FIG. 21 shows an example of a system provided herein comprising a diffractive optical element (DOE) and beam steering.

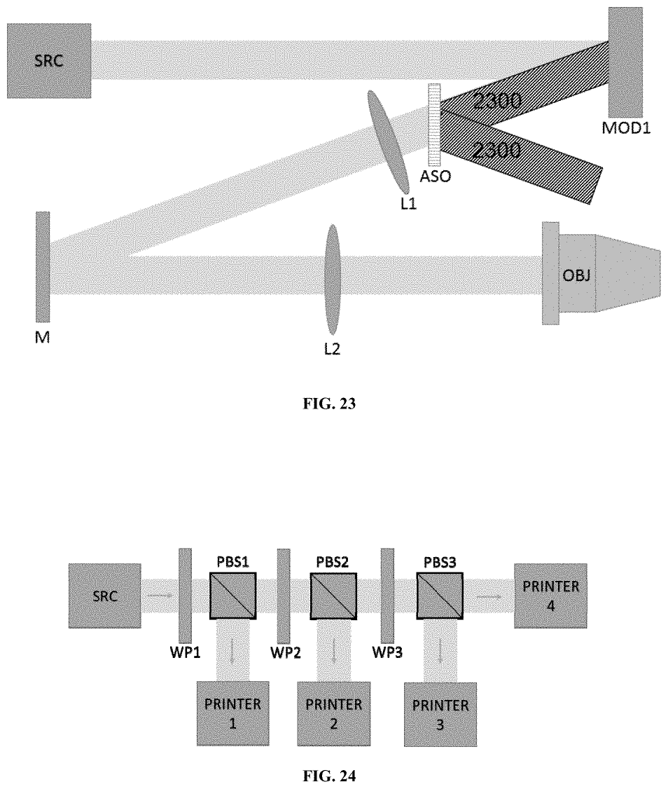

FIG. 23 shows an example of a holographic lithography setup with a single input beam. In FIG. 23, the zero-order position of the beam is marked as (2300). The abbreviation “ASO” refers to an angle-selective optic (e.g. a volumetric Bragg grating). An angle-selective optic (ASO) may be used to reject the zero-order position of the beam. The angle-selective optic (ASO) may be a Bragg grating. SRC shows an illumination source. The illumination source may be a femtosecond laser. MOD1 shows an optical modulator. An optical modulator may be a spatial light modulator. L1 and L2 show lenses. M shows a mirror. OBJ shows objective.

A holographic projection system may be configured by incorporating an angle-selective optic to reject the zero order (unmodulated) light from the projection system. In this case, an angle-selective optic (ASO) would be placed in a location where the unmodulated light would be columnated, most typically between the SLM and the first lens in the imaging system. The angle-selective optic, e.g. a volumetric Bragg grating, allows for the unmodulated (plane wave) light to be selected out from the diffracted light be way of the angular selectivity of the optic. This configuration is demonstrated in FIG. 23. In this configuration, the ASO may be used rather than a zero-order blocking spot. FIG. 23 is shown with the ASO in a transmission geometry, though reflection geometry may be used in a functionally equivalent manner. Most notably, the use of an ASO rather than a zero-order blocking spot may enable use of higher power lasers where a zero-order blocking spot placed in the focus may sustain damage, because the ASO may be placed in a columnated portion of the beam. This ASO inclusion configuration is shown in an example in FIG. 23, but this configuration may be included as a modification in any system including in any of the illustrated systems.

FIG. 24 shows a system for using one light source to power multiple printers by splitting the incoming beam into multiple beams using polarization optics. In FIG. 24, a single beam is split to power four printers. This technique may, however, be used to split a single beam into an arbitrarily large number of beams to power many printers, as long as sufficient laser power is available. This may be completed through the use of polarization optics. Polarizing beam splitters may be used to split the beam in accordance with the polarization of the incident beam. Waveplates may be used to adjust the polarization of the beam, and may control the bifurcation ratio for beam splitting at each stage. In some examples, these waveplates may be passive components (e.g. birefringent crystal or polymer waveplate) or active components (e.g. a Pockels cell or electronically switchable liquid crystal retarders). While either configuration may be used to equally divide the average power of the laser into multiple beams, in some cases, the active embodiment may be preferred. This may be preferred because the active switching may allow for the incident beam to be split pulse-wise rather than energy-wise (i.e. rather than sending one fourth of each pulse to a different printer, the entirety of every fourth pulse is sent to a different printer). This may have the benefit of delivering the highest available pulse energy to each printer, which may be beneficial for the printing process throughput.

In addition to adding utility in object fabrication, beam steering may add the additional utility of targeting. Using the combination of an imaging camera and beam steering optics, the printed object may be formed in registration with a pre-existing object. For example, a cell or cell cluster may be imaged, targeted, and a capsule may be printed around the cell/cluster. This may be an advantage of holographic lithography when using a bio-compatible print medium. The addition of steering optics may enable fast and precise targeting of objects within the print field.

The present disclosure provides computer control systems that are programmed to implement methods of the disclosure. FIG. 6 shows a computer system 1101 that is programmed or otherwise configured to redistribute an image or a complex structure for the generation of a hologram to be used in 3D holographic printing methods. The computer system 1101 can regulate various aspects of image or complex structure redistribution of the present disclosure, such as, for example, fracturing an image in 2D or in 3D, fracturing an image or complex structure by shape, performing pre-fracture field correction, and/or performing post-fracture field correction. The computer system 1101 can be an electronic device of a user or a computer system that is remotely located with respect to the electronic device. The electronic device can be a mobile electronic device.

The computer system 1101 includes a central processing unit (CPU also “processor” and “computer processor” herein) 1105, which can be a single core or multi core processor, or a plurality of processors for parallel processing. The computer system 1101 can further comprise a graphics processing unit (GPU) also identified by 1105 as shown in FIG. 6. The computer system 1101 also includes memory or memory location 1110 (e.g., random-access memory, read-only memory, flash memory), electronic storage unit 1115 (e.g., hard disk), communication interface 1120 (e.g., network adapter) for communicating with one or more other systems, and peripheral devices 1125, such as cache, other memory, data storage and/or electronic display adapters. The memory 1110, storage unit 1115, interface 1120 and peripheral devices 1125 are in communication with the CPU 1105 through a communication bus (solid lines), such as a motherboard. The storage unit 1115 can be a data storage unit (or data repository) for storing data. The computer system 1101 can be operatively coupled to a computer network (“network”) 1130 with the aid of the communication interface 1120. The network 1130 can be the Internet, an internet and/or extranet, or an intranet and/or extranet that is in communication with the Internet. The network 1130 in some cases is a telecommunication and/or data network. The network 1130 can include one or more computer servers, which can enable distributed computing, such as cloud computing. The network 1130, in some cases with the aid of the computer system 1101, can implement a peer-to-peer network, which may enable devices coupled to the computer system 1101 to behave as a client or a server.

The CPU 1105 can execute a sequence of machine-readable instructions, which can be embodied in a program or software. The instructions may be stored in a memory location, such as the memory 1110. The instructions can be directed to the CPU 1105, which can subsequently program or otherwise configure the CPU 1105 to implement methods of the present disclosure. Examples of operations performed by the CPU 1105 can include fetch, decode, execute, and writeback.

The CPU 1105 can be part of a circuit, such as an integrated circuit. One or more other components of the system 1101 can be included in the circuit. In some cases, the circuit is an application specific integrated circuit (ASIC).

The storage unit 1115 can store files, such as drivers, libraries and saved programs. The storage unit 1115 can store user data, e.g., user preferences and user programs. The computer system 1101 in some cases can include one or more additional data storage units that are external to the computer system 1101, such as located on a remote server that is in communication with the computer system 1101 through an intranet or the Internet.

The computer system 1101 can communicate with one or more remote computer systems through the network 1130. For instance, the computer system 1101 can communicate with a remote computer system of a user (e.g., a desktop). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1101 via the network 1130.

Methods as described herein can be implemented by way of machine (e.g., computer processor) executable code stored on an electronic storage location of the computer system 1101, such as, for example, on the memory 1110 or electronic storage unit 1115. The machine executable or machine readable code can be provided in the form of software. During use, the code can be executed by the processor 1105. In some cases, the code can be retrieved from the storage unit 1115 and stored on the memory 1110 for ready access by the processor 1105. In some situations, the electronic storage unit 1115 can be precluded, and machine-executable instructions are stored on memory 1110.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 1101, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1101 can include or be in communication with an electronic display 1135 that comprises a user interface (UI) 1140 for providing, for example, an image of the complex structure to be processed by the methods disclosed herein. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 1105. The algorithm can, for example, measure the compactness of an image, apply a mask to score each voxel of a shape, and/or fracturing an image to create a hologram.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1.-72. (canceled)

73. A method for processing a computer representation of a three-dimensional (3D) object, comprising:
(a) computer processing said computer representation of said 3D object to generate a first plurality of parts of said 3D object, wherein said first plurality of parts have different volumes;
(b) computer processing said first plurality of parts to yield a second plurality of parts that have substantially identical volumes; and
(c) using said second plurality of parts to generate printing instructions for generating said 3D object.

74. The method of claim 73, further comprising using said printing instructions to print said 3D object.

75. The method of claim 74, wherein said 3D object is printed by polymerizing a medium in accordance with said printing instructions.

76. The method of claim 73, wherein said second plurality of parts is part of a holographic representation of said 3D object.

77. The method of claim 73, further comprising generating a phase-space hologram by applying a phase-space transformation to said first plurality of parts.

78. The method of claim 77, wherein said phase-space transformation is a translation operation.

79. The method of claim 73, wherein said 3D object is an amorphous 3D object.

80. The method of claim 73, wherein a shape of a part of said first plurality of parts and a shape of a part of said second plurality of parts are selected in accordance with the compactness of each shape.

81. The method of claim 80, wherein said shape of said part of said first plurality of parts and said second shape of said part of said second plurality of parts are selected through a clustering algorithm.

82. The method of claim 73, wherein each of said second plurality of parts interlock.

83. A method of generating a continuous hologram, said method comprising superimposing a first energy beam and a second energy beam such that said first energy beam generates a first zero-order defect and said second energy beam generates a second zero-order defect that does not overlap said first zero-order defect, to yield said continuous hologram.

84. The method of claim 83, wherein said continuous hologram is used to print a three-dimensional (3D) object.

85. The method of claim 84, wherein said 3D object is printed by polymerizing a medium.

86. The method of claim 83, wherein said continuous hologram is a holographic representation of a three-dimensional (3D) object.

87. The method of claim 83, wherein said first energy beam and said second energy beam are aligned.

88. The method of claim 83, further comprising physically blocking said zero-order defect in or near an image plane.

89. The method of claim 83, further comprising rejecting said zero-order defect using an angle-selective optic.

90. The method of claim 83, wherein said first energy beam and said second energy beam are handled separately.

91. The method of claim 83, further comprising setting an intensity of said first energy beam and said second energy beam such that each of said first energy beam and said second energy beam have sufficient energy to expose said first zero-order defect and said second zero-order defect to said first energy beam or said second energy beam.

92. The method of claim 83, further comprising for each of said first energy beam and said second energy beam applying an increased intensity to either of said first zero-order defect or said second zero-order defect that exists within a print area of said first energy beam or said second energy beam.
